(19) United States
(12) Patent Application Publication
(10) Pub. No.: US 2026/0101357 A1
(43) Pub. Date: Apr. 9, 2026

(54) EFFICIENT LOW-LATENCY CSI ACQUISITION IN A DOWNLINK BURST

(71) Applicant: INTERDIGITAL PATENT HOLDINGS, INC., Wilmington, DE (US)

(72) Inventors: Patrick Svedman, Stockholm (SE); Kyle Jung-Lin Pan, Saint James, NY (US); Allan Yingming Tsai, Boonton, NJ (US); Arman Shojaeifard, London (GB)

(73) Assignee: INTERDIGITAL PATENT HOLDINGS, INC., Wilmington, DE (US)

(21) Appl. No.: 19/114,358

(22) PCT Filed: Sep. 22, 2023
(86) PCT No.: PCT/US2023/033488

§ 371 Date: Mar. 21, 2025

Related U.S. Application Data
(60) Provisional application No. 63/409,672, filed on Sep. 23, 2022.

(51) Int. Cl. H04W 72/232; H04L 5/00; H04W 72/0446; H04W 72/0453

(52) U.S. Cl. CPC H04W 72/232; H04L 5/0048; H04W 72/0446; H04W 72/0453

(57) ABSTRACT

Methods and devices are disclosed for a wireless transmit receive unit (WTRU). The WTRU is configured with information including a downlink (DL) burst format table defining a plurality of DL burst formats. A DL burst format includes a time domain resource allocation (TDRA) of one or more physical downlink shared channels (PDSCHs), one or more sounding reference signal (SRS) resources and/or channel state information reference signal (CSI-RS) resources associated with the DL burst format. The WTRU may receive downlink control information (DCI) with a field indicating a select DL burst format from the DL burst format table that defines time domain positions of all signals associated with the select DL burst to the WTRU. The WTRU may then transmit SRS(s) and receive CSI-RS(s), if any, and one or more PDSCHs using the TDRA associated with the indicated select DL burst format. Additional embodiments are disclosed.

### CROSS-REFERENCE TO RELATED APPLICATIONS

This application claims the benefit of U.S. Provisional Application No. 63/409,672, filed Sep. 23, 2022, the contents of which are incorporated herein by reference.

### BACKGROUND

The performance of future wireless communication systems may rely on timely and accurate CSI (Channel State Information). But in the case of DL (Downlink) CSI based on SRS (sounding reference signal), the delay between SRS transmission and the corresponding PDSCH (physical downlink shared channel) may be too long for suitable performance of such future wireless communication systems.

Dynamically scheduled physical downlink shared channel (PDSCH) transmission and reception may be based on prior SRS and/or CSI-RS, e.g., for CSI acquisition, beam management, and time-frequency (t/f) synchronization. With time-varying channels (e.g., many antennas, high frequency, high mobility, etc.), it is beneficial to transmit/receive the SRS and/or CSI-RS as close in t/f as possible to the corresponding PDSCH(s) (given the mobile and base station capabilities, etc.). In legacy systems, PDSCH, SRS and/or CSI-RS can be separately scheduled/triggered by DL control information (DCI), with either: (i) higher t/f domain flexibility for PDSCH than for aperiodic SRS and/or CSI-RS which provides for less DCI overhead but suboptimal t/f allocation of SRS and/or CSI-RS; and/or (ii) similar t/f domain flexibility for PDSCH, SRS, and/or CSI-RS with a higher DCI overhead, but better t/f allocation of SRS and/or CSI-RS. It would be desirable for solutions to enable “optimal” SRS and/or CSI-RS t/f allocation (in relation to the PDSCH) with low DCI overhead.

### SUMMARY

Aspects of the present disclosure may describe embodiments to configure and trigger/activate DL bursts which may comprise SRS, CSI-RS and PDSCH in a sequence optimized for timely DL CSI acquisition and low control overhead. According to one aspect, SRS/CSI-RS resources are linked to rows in the PDSCH time-domain resource allocation (TDRA) table and triggered by the TDRA DCI field, e.g., SRS slot/symbol offset is determined from the PDSCH starting time. The frequency allocation of a triggered SRS may be based on the PDSCH frequency-domain resource allocation (FDRA) in the FDRA DCI field.

The BS may want to adjust the PDSCH transmission upon reception of SRS that was triggered by 1st DCI. A subsequent 2nd DCI may adjust information in the 1st DCI, e.g., adjust PDSCH MCS, rank, t/f resource allocation. The 2nd DCI may be in a 2nd PDCCH (e.g., without blind decoding) or multiplexed in a PDSCH. CSI-RS for tracking (TRS) is enhanced to support P3 beam management (UE Rx beam sweeping). As described herein, a user equipment (UE) may be interchangeably referred to a wireless transmit receive unit (WTRU).

An embodiment includes an electronic apparatus having a WTRU that is configurable by a network having one or more SRS resources, one or more CSI-RS resources, and one or more time-domain resource allocations (TDRA) for one or more PDSCHs.

The performance of future wireless communication systems may rely on timely and accurate CSI (Channel State Information). In the case of DL (Downlink) CSI based on SRS (sounding reference signal), the delay between SRS transmission and the corresponding PDSCH (physical downlink shared channel) should be kept as low as possible. Aspects of this disclosure propose methods to configure and trigger/activate DL (downlink) bursts which may comprise a SRS (sounding reference signal), a CSI-RS (Channel State Information Reference Signal), and a PDSCH (physical downlink shared channel) in a sequence configured for timely DL CSI (downlink channel state information) acquisition and low control overhead.

Features of systems described herein include 3GPP Target Feature and Release, Advanced MIMO, MIMO revolution, massively distributed MIMO (MD-MIMO), ultra-massive MIMO (UM-MIMO), cell-free MIMO (CF-MIMO), L1, L2/3.

Procedures and functions described herein include scheduling, link adaptation, PDSCH (physical downlink shared channel) resource allocation, PDCCH (Physical Sidelink Control Channel), and SRS (Sounding Reference Signal)

Embodiments described herein include a WTRU configured with multiple DL (down link) burst formats including SRS for DL CSI acquisition, CSI-RS, and one or more PDSCH (physical downlink shared channel), a DL burst format is indicated in DCI Downlink Control Information, e.g., via the PDSCH TDRA field or via a new field such as a DL burst format indicator, where a DL burst format includes the TDRA (Time Domain Resource Allocation) of the one or more PDSCH (physical downlink shared channel), a DL (Downlink) burst format can include a SRS/CSI-RS location in time that is configured for the PDSCH TDRA, the DCI is split into a 1st DCI and 2nd DCI, the 1st DCI triggers the DL (Downlink) burst format, the 2nd DCI indicates/adjusts PDSCH parameters based on SRS measurements. The 2nd DCI may be received in a PDCCH without blind decoding or may be multiplexed in a PDSCH. The 1st and 2nd DCI may be in different bandwidth parts (BWPs). The frequency domain resource allocation (FDRA) of the SRS for DL Downlink CSI can be based on the PDSCH FDRA, and a TRS enhanced with repetition can facilitate both tracking and beam management by the same RS.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a diagram of an aperiodic SRS triggering timeline according to an embodiment;

FIG. 3 is a diagram of a DL burst according to an embodiment;

FIG. 4 is a diagram of a DL burst according to another embodiment;

FIG. 5 is a diagram of a DL burst according to yet another embodiment;

FIG. 6 is a diagram of a UL burst according to an embodiment;

FIG. 7 is a flow diagram of a WTRU procedure according to an embodiment;

FIG. 8 is a diagram of a DL burst according to still another embodiment;

FIG. 9 is a diagram of a 1st DCI scheduling DL bursts on multiple carriers according to an embodiment;

FIG. 10 is a diagram of a 2nd DCI triggering an SRS transmission according to an embodiment;

FIG. 11 is a diagram of a 1st and 2nd PDCCH according to an embodiment;

FIG. 12 is a diagram of a 2nd CORESET being separate from a 1st CORESET according to an embodiment;

FIG. 13 is a diagram of multiple rounds of SRS transmission in a DL burst according to an embodiment;

FIG. 14 is a diagram of SRS sounding bandwidth according to an embodiment;

FIG. 15 is a diagram of partial sounding of SRS sounding bandwidth according to an embodiment;

FIG. 16 is a diagram of flexible SRS transmission bandwidth according to an embodiment;

FIG. 17 is a diagram of flexible SS transmission bandwidth according to another embodiment;

FIG. 18 is a diagram of adaptation of a SRS starting resource bandwidth (RB) and sounding bandwidth according to an embodiment;

FIG. 19 is a diagram of TRS with repetition (for beam management) according to an embodiment;

FIG. 20 is a diagram of TRS with repetition (for beam management) according to another embodiment;

FIG. 21 is a diagram of a configuration of linking between SRS resource sets and TDRA table rows according to an embodiment;

FIG. 22 is a flow diagram of a WTRU procedure according to another embodiment; and

FIG. 23 is a flow diagram of a WTRU procedure according to yet another embodiment.

### DETAILED DESCRIPTION

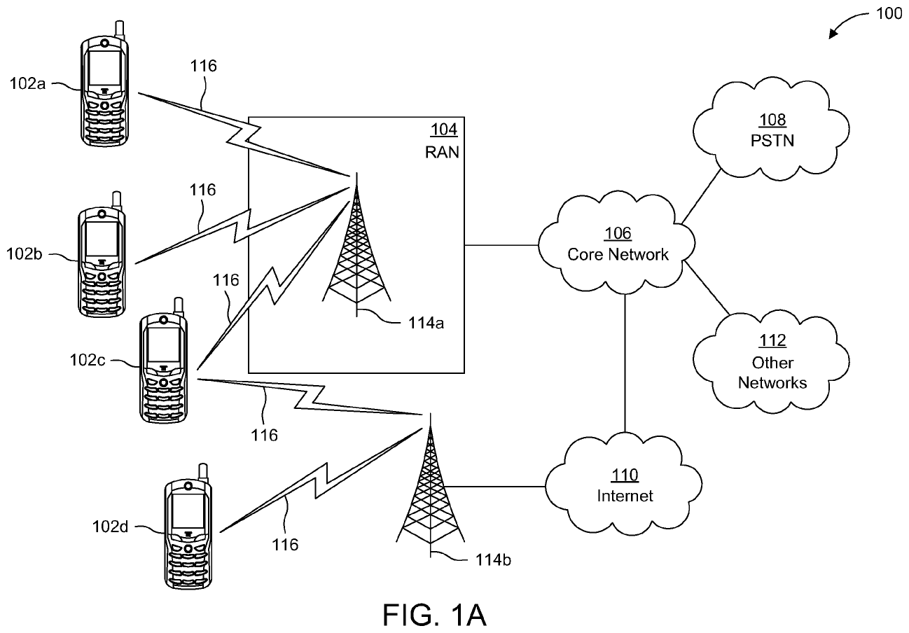

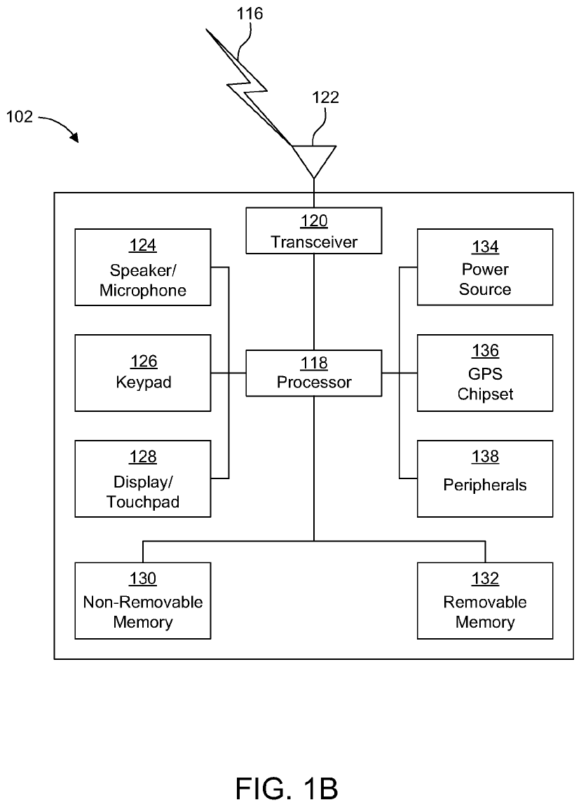

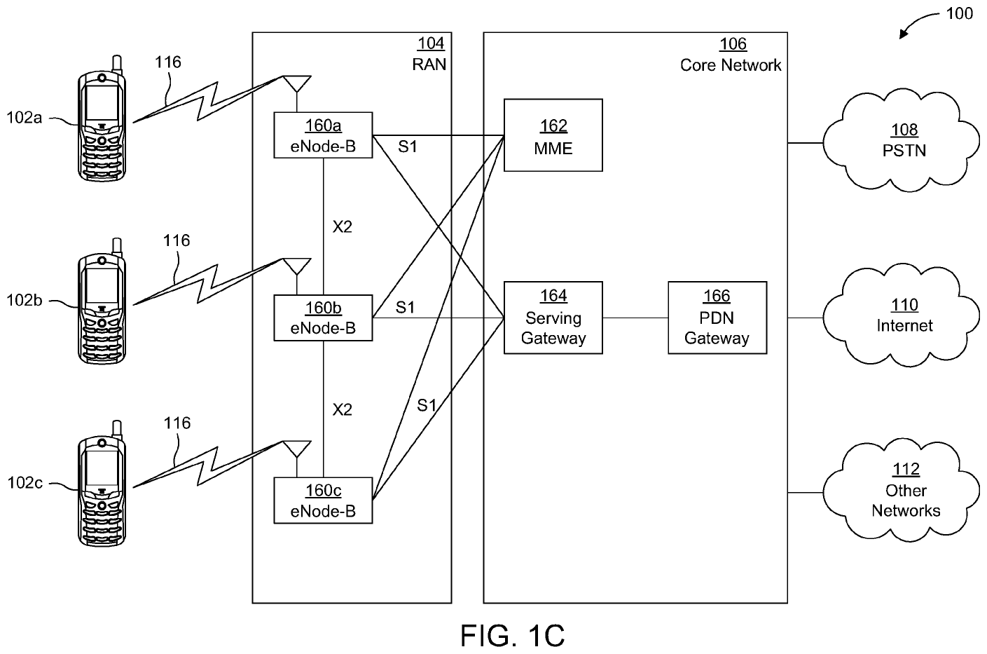

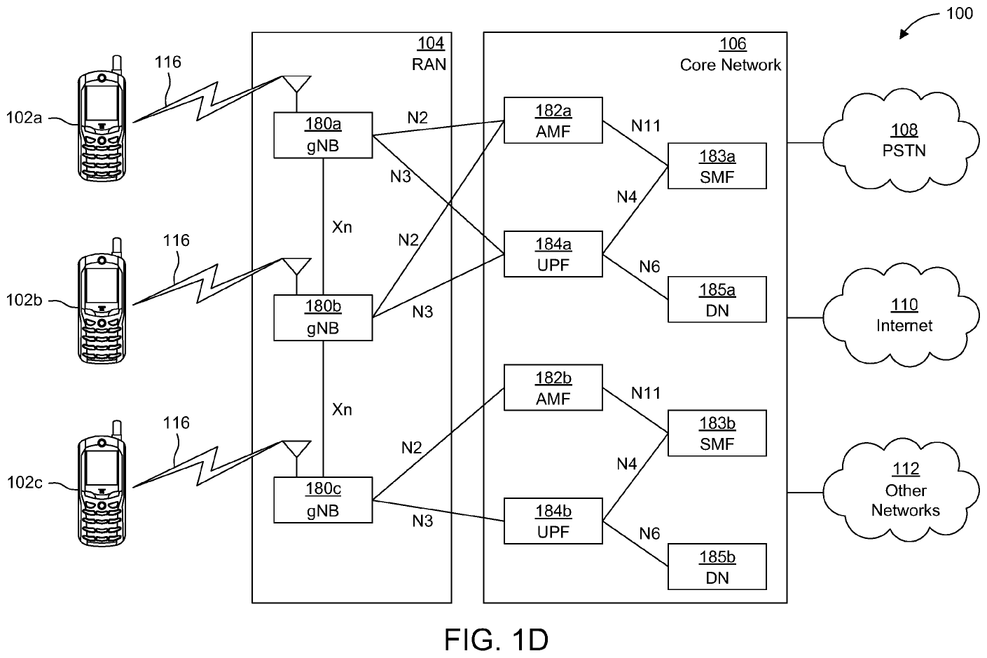

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHz, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHZ, and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHZ. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In MIMO communication, multiple antennas at the transmitter and receiver are used to improve communication performance, e.g., by spatial multiplexing, spatial diversity, and/or beamforming. In a wireless network, the multiple transmit/receive antennas may be deployed at transmission/reception points (TRPs). In a traditional wireless network, one TRP per cell has typically been used. The TRP has typically been equipped with multiple antennas. More recently, TRPs with large numbers, even hundreds, of antennas have been deployed, supporting massive MIMO schemes.

Another trend is to deploy additional TRPs in a cell. A benefit of such a deployment is a reduced average distance and pathloss between a WTRU and the nearest TRP, thereby allowing lower transmit power and hence lower interference in the system. Another benefit is improved spatial diversity, which means that there may be several candidate TRPs that may serve a WTRU. If the radio link to a serving TRP is blocked, the WTRU may instead be served by another TRP without a blocked radio link.

In a distributed MIMO system, the antennas are not located at one or a few TRPs. Instead, the antennas are even more distributed throughout the wireless network. In some definitions, distributed MIMO also includes the case with a few TRPs. Distributed MIMO transmission/reception may include for example coherent joint transmission (in the DL) and reception (in the UL), non-coherent transmission, single-frequency network (SFN) based transmission, involving distributed antennas or a few TRPs.

A massively distributed MIMO system (also called distributed massive MIMO) combines the large number of antennas in a massive MIMO system with the distributed antennas in a distributed MIMO system. For example, the hundreds of antennas previously co-located at a massive MIMO TRP that covers a geographic area are distributed throughout the area. Subsets of antennas may be co-located at TRPs (sometimes called access points). The massively distributed MIMO deployment promises very high theoretical performance under ideal assumptions. However, there are numerous challenges to achieve those performance gains in practice, including fronthaul, synchronization, etc.

Sounding Reference signals (SRS) may be transmitted by a WTRU based on a SRS configuration, activation, triggering, etc., by the network. The network may receive and perform measurements on the SRS, e.g., to estimate the uplink (UL) radio channel, estimate the downlink (DL) channel, estimate various parameters such as UE (WTRU) Doppler shift or spread or UE (WTRU) time offset or delay spread, angular direction of the UE (WTRU), UE (WTRU) position, UL beam management, DL beam management, multi-UE (WTRU) pairing for DL or UL multi-user MIMO, etc.

In some cases, e.g., in systems employing time-division duplex (TDD) and with DL/UL transceiver calibration or other methods to make the effective downlink (DL) radio channel including the DL transmitter hardware similar or equal to the effective UL radio channel including the UL receiver hardware, an estimate of the downlink (DL) radio channel may be obtained from the estimated UL radio channel. This is often called DL/UL reciprocity, or just reciprocity.

In a system with reciprocity, the SRS may therefore be used to obtain DL channel state information at the network side. This is an alternative to the method to estimate the DL CSI at the WTRU based on DL RS, e.g., CSI-RS, SSB, or DMRS, and to feedback quantized or unquantized CSI from the WTRU to the network. While the DL CSI is used at the WTRU side to receive the DL transmissions, the DL CSI is used at the network side in order to adapt properly the DL transmissions, e.g., in terms of modulation and coding scheme (MCS), multi-antenna precoding, etc.

An advantage of DL CSI acquisition based on SRS is that the DL CSI is readily available at the network side and can be immediately used for adapting DL transmissions. This means that the CSI feedback delay can be avoided, which includes the time between DL RS reception and corresponding CSI feedback transmission, as well as the CSI feedback processing delay at the network.

DL CSI acquisition based on SRS may also be particularly efficient in a massively distributed MIMO system. For example, consider a simple example with 100-antennas at the network side and 1-WTRU antenna. The DL CSI, therefore, comprises 100 radio channels. With DL CSI acquisition based on WTRU measurement of DL RS, 100-DL RSs would be needed to estimate the 100 channels. Also, the quantized CSI report may have to represent the 100 channels. On the other hand, DL CSI acquisition based on SRS would require only a single SRS that could be received at the 100 antennas and that could be used to estimate all 100 channels, exploiting reciprocity. This example illustrates a potentially large overhead reduction from using SRS instead of DL RS in DL CSI acquisition in massively distributed MIMO systems.

SRS in 5G NR can provide a flexible framework for network-controlled WTRU transmission of SRS resources. Several properties of an SRS resource may be configured. A few of the properties are discussed below.

The network may provide a spatial reference RS for an SRS resource (the target RS). The WTRU transmits the target SRS resource with the same spatial domain filter (e.g., UL Tx beam and/or UL Tx panel) used for the reception (e.g., DL Rx beam and/or DL Rx panel) of the reference RS.

The frequency resources spanned by an SRS resource are also configured, as well as a frequency hopping pattern, if any. SRS resources may be grouped in SRS resource sets. Some properties may be configured per SRS resource set. The SRS resources in an SRS resource set may be periodic, semi-persistent (SP), or aperiodic (AP).

Periodic SRS resources are transmitted periodically after being configured. A spatial reference RS may be configured for a periodic SRS resource.

Semi-persistent (SP) SRS resources are transmitted periodically after being activated and until being deactivated. The activation/deactivation is carried in a MAC CE and applies to an SP SRS resource set, i.e., all SRS resources in the set are jointly activated/deactivated. A spatial reference RS may be configured for an SP SRS resource. Furthermore, the activation/deactivation MAC CE may update the spatial relation RS of the SRS resources in the SRS resource set.

Aperiodic (AP) SRS resources are transmitted upon being triggered by a downlink control information (DCI) carried in a physical downlink control channel (PDCCH). An AP SRS resource set may be configured with one or more AP SRS resource trigger values. An AP SRS resource set is triggered if a DCI indicates an AP SRS resource trigger value with the field ‘SRS request’ equal to a trigger value configured for the AP SRS resource set. In other words, a DCI may trigger multiple SRS resource sets.

An AP SRS resource may be configured with a spatial reference RS. The spatial reference RSs for the AP SRS resources in an AP SRS resource set may be updated using a MAC CE.

A unified transmission configuration indicator (TCI) framework has been introduced, in which the spatial reference RS (also called quasi co-location (QCL) source RS) for all SRS resources in one or more SRS resource sets may be updated using a MAC CE or a DCI. The spatial reference RS is configurable per SRS resource set if the spatial reference RS is to be updated using the new mechanism. The unified TCI framework allows the joint and simultaneous update of a TCI state for various DL signals/channels, e.g., PDCCH, PDSCH, CSI-RS, and various UL signals/channels, e.g., PUCCH, PUSCH, SRS. In one example, the TCI state for PDSCH (including a spatial QCL source RS) and the spatial reference RS for one or more SRS resource sets with usage ‘antennaSwitching’ are jointly and simultaneously updated to the same DL RS. This allows for simultaneous beam switching with low overhead of both PDSCH and the SRS used for PDSCH CSI acquisition.

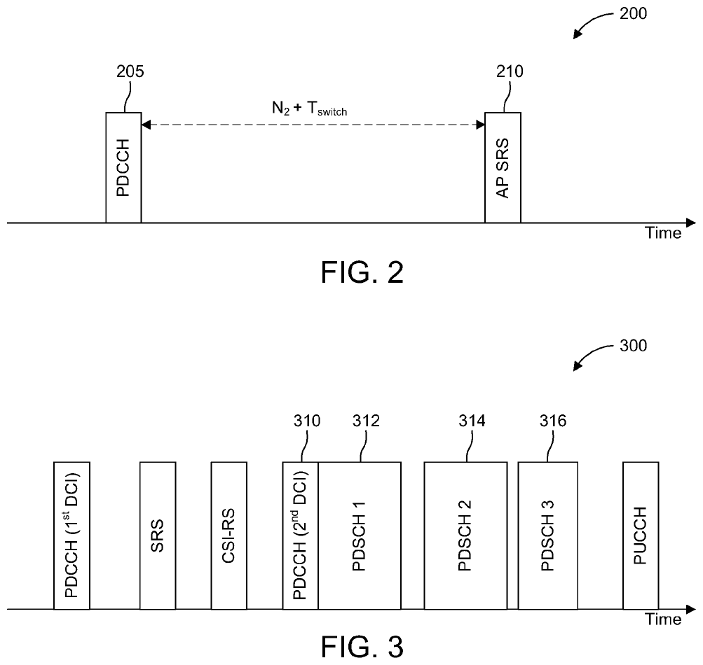

Referring to FIG. 2, an example aperiodic SRS Timeline 200 is shown, which can be the minimum time between the last symbol of a PDCCH 205 triggering an aperiodic SRS 210 and the first symbol of the triggered SRS resource, is typically defined. In one example for SRS for antenna switching, the minimum time is N2+Tswitch, as illustrated in FIG. 2, where N2 is given by Table 1 below, for two different WTRU processing capabilities and Tswitch is a UL switching gap between 35-210 μs, i.e., roughly ½-3 symbols for 15 kHz subcarrier-spacing (numerology u=0).

TABLE 1
N₂ for different WTRU processing capabilities

| | N₂ [symbols] for WTRU | N₂ [symbols] for WTRU |
|---|---|---|
| μ (numerology) | processing capability 1 | processing capability 2 |
| 0 | 10 | 5 |
| 1 | 12 | 5.5 |
| 2 | 23 | 11 for frequency range 1 |
| 3 | 36 | — |
| 5 | 144 | — |
| 6 | 288 | — |

CSI-RS is a multi-purpose DL RS in 5G NR. CSI-RS are organized in CSI-RS resources and CSI-RS resource sets, which may comprise one or more CSI-RS resources. Several kinds of DL CSI resources are defined in NR, for example: non-zero power (NZP) CSI-RS resources, zero-power (ZP) CSI-RS resources and CSI interference measurement (IM) resources.

NZP CSI-RS resources carry CSI-RS with parameters known by the WTRU and on which the WTRU can perform various signal and channel measurements. Unless otherwise noted, ‘CSI-RS resource’ and ‘CSI-RS resource set’ respectively refer to NZP CSI-RS resource and NZP CSI-RS resource set.

The ZP CSI-RS resource may comprise a similar configuration of resource elements (REs) as an NZP CSI-RS resource but sometimes without containing a CSI-RS. A ZP CSI-RS resource may be used for rate matching of PDSCH.

A CSI IM resource may comprise a set of REs on which a WTRU may perform noise and interference measurements.

CSI-RS in NR may be used for various purposes such as beam management, mobility, CSI acquisition, and time-frequency tracking.

CSI-RS for beam management may correspond to a CSI-RS resource set with the parameter repetition configured, e.g., with repetition set to ‘on’ or to ‘off’.

CSI-RS for tracking, also called tracking RS (TRS), is a CSI-RS resource set with certain properties. The TRS may span one or two adjacent time slots. A WTRU may use TRS for fine time-frequency tracking. To this end, PDCCH DMRS and PDSCH DMRS may have a TRS as a QCL source RS, for example with QCL type A and QCL type D. QCL type A means that the WTRU may estimate Doppler shift, Doppler spread, average delay, and delay spread from the TRS and apply the estimates to reception of PDCCH/PDSCH DMRS. QCL type D means that the WTRU may estimate a spatial Rx parameter from the TRS, e.g., an Rx beam and/or an Rx panel, to be used for PDCCH/PDSCH DMRS reception. QCL type D may be used in beamformed systems, e.g., in mmWave, sub-THz, or THz frequencies. The network work may transmit different TRS using different transmit beams and even from different TRPs. Given that different transmit beams or TRPs may result in different propagation paths, the fine time-frequency tracking and spatial Rx parameters may, therefore, differ between different TRSs received by a WTRU.

CSI-RS resources may in general be periodic, semi-persistent, or aperiodic. TRS may be periodic or aperiodic. However, an aperiodic TRS typically uses a periodic TRS as QCL source RS, which means that a periodic TRS is typically configured for a connected mode WTRU. An aperiodic TRS may be used to allow timely TRS reception prior to PDCCH/PDSCH reception instead of periodic TRS transmission with low periodicity.

A periodic TRS has a Synchronization Signal/PBCH Block (SSB) as QCL source with type C (for Doppler shift and average delay). A periodic TRS also may be configured with a QCL source RS with type D (for a spatial Rx parameter), which may be an SSB or a CSI-RS resource for beam management.

An aperiodic TRS starts in a symbol after the last symbol of the PDCCH that triggered the TRS. In FR1, the minimum delay may be 0 symbols. In FR2, the minimum delay may be given by a WTRU capability (e.g., beamSwitchTiming which may be for example 14, 28, 48 symbols).

The time-slot offset between a triggering PDCCH and the corresponding aperiodic TRS is configurable (0, 1, 2, . . . time slots) and may differ between aperiodic CSI-RS resource sets.

Support of a single DCI scheduling multiple PDSCH (or multiple PUSCH) in the context of extending support up to 71 GHz has been introduced. Various relevant aspects of the enhancement are summarized here:
A single DCI (format 1_1) may schedule up to 8 PDSCH
Different PDSCH have separate transport blocks (TBs)
Each PDSCH has 1 TB or each PDSCH has 2 TBs.
Each PDSCH is confined within a time slot.
The indicated PDSCH to HARQ timing is the time-slot offset between time slot of the last PDSCH and the time slot carrying the HARQ-ACK information.
HARQ-ACK info is carried in the same PUCCH resource.
DCI includes one (a first) MCS for the 1^{st} TB that applies to the 1^{st} TB of each PDSCH.
DCI includes a second MCS for the 2^{nd} TB that applies to 2^{nd} TB of each PDSCH, if applicable.
DCI includes a new data indicator (NDI) for each TB of each PDSCH.
DCI indicates a redundancy version (RV) for TB of each PDSCH.
DCI includes one HARQ process number, which applies to the first PDSCH.
HARQ process number is incremented by 1 for each subsequent PDSCH (with modulo).
DCI indicates a row in the configured Time-domain resource allocation (TDRA) table. The TDRA table is extended such that each row indicates up to 8 multiple PDSCHs.
Each PDSCH has a separate {start and length indicator value (SLIV), mapping type, scheduling offset K0}.
The number of scheduled PDSCHs is implicitly indicated by the number of valid SLIVs in the row of the TDRA table indicated by the DCI.
The WTRU does not ‘expect’ to be configured with numberOfRepetitions for the TDRA table for DCI format 1_1. However, numberOfRepetitions may be configured for the TDRA table for DCI format 1_2.
The PDSCH may be in consecutive or non-consecutive time slots.
If a PDSCH collides with and UL symbol, the PDSCH is dropped.
DCI includes a single TCI field, which may correspond to one or two TCI states (as in Rel-16 multi-TRP enhancement for PDSCH).
One TCI state: same TCI state is applied to each PDSCH.
Two TCI states: use Rel-16 rules for association between TCI state and PDSCH

5G NR sidelink control information (SCI) may be split into a 1st stage SCI and a 2nd stage SCI, where the 1st stage SCI is transmitted in a Physical Sidelink Control Channel (PSCCH) and the 2nd stage SCI is multiplexed in a Physical Sidelink Shared Channel (PSSCH).

The 1st stage SCI includes scheduling information for a PSSCH, such as time and frequency resource assignments, DMRS pattern, and MCS. It may also include a resource reservation period, which may be useful also for sidelink WTRUs to which the PSSCH is not intended. The 1st stage SCI may also indicate a format for the 2nd stage SCI as well as a beta offset value for the 2nd stage SCI that may be used to control the amount of modulation symbols (or resource elements) used for the 2nd stage SCI.

The 2nd stage SCI may include various information, depending on the format, such as HARQ process number, new data indicators (NDI), redundancy version (RV), source and destination ID, cast type indicator, CSI request, etc.

The 1st stage SCI may need to be received by a larger set of WTRUs than the WTRUs to which the PSSCH is targeted. Hence, the PSCCH (with the 1st stage SCI) may be transmitted in a broadcast manner, e.g., using a wide beam, diversity transmission, multi-TRP transmission, and/or SFN transmission, whereas the PSSCH (incl. 2nd stage SCI) may be transmitted with a narrow beam targeting the intended WTRU(s).

The first release of 5G NR was designed for high flexibility and forward compatibility. A potential drawback of a flexible design is unnecessarily high complexity and latency in the most typical use cases. In subsequent releases of 5G NR, this has been addressed by adding configurable modes of operation with significant less degrees of freedom, but with greater efficiency.

In terms of dynamically acquiring CSI based on SRS for a burst of just arrived DL/UL data, existing cellular communication systems such as 4G LTE, LTE-A, and 5G NR allow great flexibility, e.g., in terms of aperiodic SRS triggered by DCI, aperiodic TRS triggered by DCI and PDSCH/PUSCH dynamically scheduled by DCI. The SRS triggering, TRS triggering, and PDSCH/PUSCH scheduling are independent, which allows for great flexibility. But the flexibility may come at the cost of DCI higher payload size, larger DCI overhead, and potentially larger latency.

For future communications systems and deployment scenarios, for instance massively distributed MIMO, timely CSI acquisition is often of utmost importance for the communication performance. Therefore, it may be worthwhile to sacrifice some flexibility in order to reduce CSI acquisition latency. Described below are one or more embodiments of a technique to reduce the delay between an SRS that is used for CSI acquisition and the corresponding first PDSCH or PUSCH to which the acquired CSI is applied.

As in introduction to Downlink (DL) or Uplink (UL) Burst, state-of-the-art systems may support flexible scheduling, triggering, etc., of various individual signals and/or channels (“signals/channels”), often at the cost of increased signaling overhead and with separate processing timelines for different signals/channels. In many cases, however, the same set of signals/channels may be used repeatedly and in the same order, to support DL/UL data transmission.

For simplicity of presentation, embodiments based on the DL, which may be used for efficient DL data transmission, are described. However, the described embodiments (methods and procedures) may also be applied to UL data transmission, e.g., single-panel UL transmission, simultaneous multi-panel UL transmission, a UL burst, etc., in which PDSCH may be replaced by PUSCH, and SRS for DL CSI acquisition (e.g., with usage antenna switching) may be replaced by SRS for UL CSI acquisition (e.g., SRS for codebook-based or non-codebook based PUSCH operation) and/or SRS for UL beam management.

A purpose of a downlink (DL) burst is to enable efficient DL data transmission, for example by enabling short delay between SRS transmission and PDSCH reception, and low control signaling overhead. One or more typical set(s) of signals/channels with a relation in time that is designed for a particular WTRU may be configured and used repeatedly.

A DL burst may be a collection of signals/channels that are concentrated in time and that are used for DL data communication. The signals/channels may include DL and/or UL signals/channels. The signals/channels may be periodic, semi-persistent, and/or aperiodic (also in various combinations). The concentration in time may refer to the transmission/reception of the signals/channels within some time duration, for example a few time slots, subframes, radio frames, milliseconds, etc. A DL burst may be periodic, semi-persistent, or aperiodic, for example based on the properties of the signals/channels comprising a DL burst.

The reception of a DL burst, or parts thereof, may be scheduled by the network, e.g., using a DCI in a PDCCH or by a MAC CE in a PDSCH. Reception of semi-persistent DL bursts, or parts thereof, may be activated (and deactivated) by the network, e.g., using a DCI in a PDCCH or by a MAC CE in a PDSCH. Reception of periodic DL bursts, or parts thereof, may be configured by the network, e.g., using RRC signaling.

Various structures, components, and/or timelines of a DL burst, or parts thereof, may be configurable, indicated by a DCI (e.g., triggering, scheduling, or activating DCI), or indicated by a MAC Control Element (CE). A DL burst may include one or more of the following:
A first DCI in a first PDCCH, e.g., for scheduling or activating the DL burst, or a part of the burst. In some cases, the first DCI may be considered not to be a part of the DL burst.
One or more SRS, e.g., for DL CSI acquisition, antenna switching, or beam management.
One or more CSI-RS, e.g., for tracking and/or beam management.
A second DCI, e.g., in a second PDCCH, or multiplexed in a PDSCH.
One or more PDSCH transmissions.

One or more PUCCH transmissions. In some cases, the PUCCH following a PDSCH may be considered not to be a part of the DL burst.

A burst may have a burst format that may be configurable, at least partly. Various exemplary burst formats are illustrated in FIGS. 3-6.

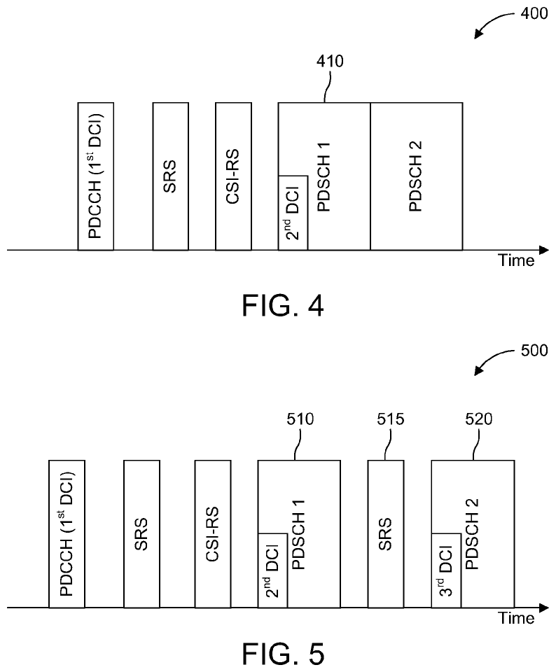

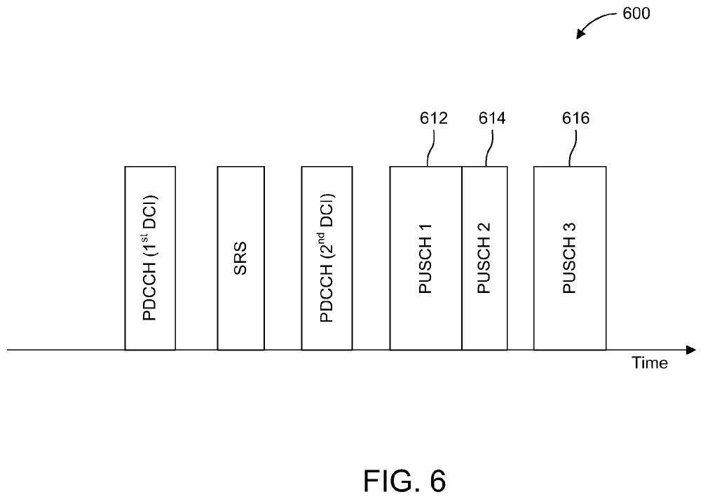

Referring to FIG. 3, an exemplary diagram of a DL burst 300 is shown with a 2nd DCI carried in a PDCCH 310 and three PDSCH transmissions 312, 314, 316. FIG. 4 shows an exemplary illustration of a DL burst 400 with a 2nd DCI multiplexed in a first PDSCH 410. Advantages/disadvantages of multiplexing the 2nd DCI in the PDSCH (as in FIG. 4) compared to transmitting the 2nd DCI in a PDCCH (as shown in FIG. 3) are further discussed herein. FIG. 5 shows an exemplary illustration of a DL burst 500 with an SRS transmission 515 between the 1st PDSCH transmission 510 and 2nd PDSCH transmission 520, as well as a 3rd DCI piggy-backed in the 2nd PDSCH 520. FIG. 6 shows an exemplary illustration of an UL burst 600 with three PUSCH transmissions 612, 614 and 616.

The multiple PDSCHs (or PUSCHs) in a DL burst (or UL burst) may carry different transport blocks or the same transport block, depending on configuration and/or dynamic indication. In some cases, a subset of the PDSCHs (or PUSCHs) may carry the same transport block while other PDSCHs (or PUSCHs) may carry other transport block(s). In one example with 4 PDSCHs in a DL burst, a first pair of PDSCHs carry a first transport block and a second pair of PDSCHs carry a second transport block. A transport block carried by multiple PDSCHs (or PUSCHs) may be repeated across the multiple PDSCHs (or PUSCHs) or mapped across the multiple PDSCHs (or PUSCHs), e.g., similar to conventional PUSCH TB processing over multi-slot PUSCH in NR.

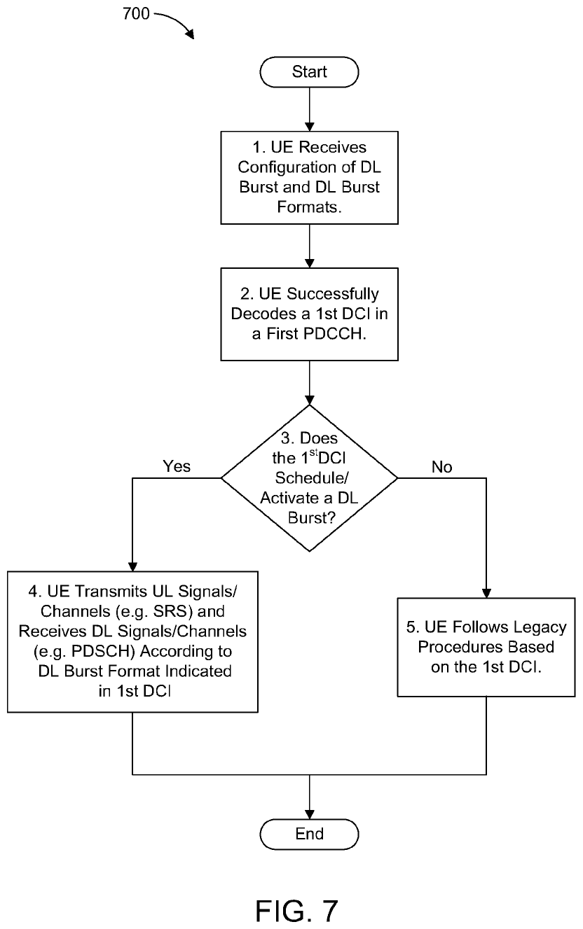

Referring to FIG. 7, an exemplary high-level WTRU procedure 700 is shown. Further details and variations on the various steps are discussed below. One or more signals/channels in a burst may be cancelled and not transmitted or received. For example, a DL signal/channel in a burst may be cancelled if it collides with a higher-priority DL signal/channel, such as an SSB, or symbols that have been configured or indicated to be UL symbols. For example, an UL signal/channel may be cancelled if it collides with a higher-priority UL signal/channel, or symbols that have been configured or indicated to be DL symbols.

Furthermore, signals/channels in a burst that are not cancelled may be rate matched around other signals/channels that may or may not be part of the burst.

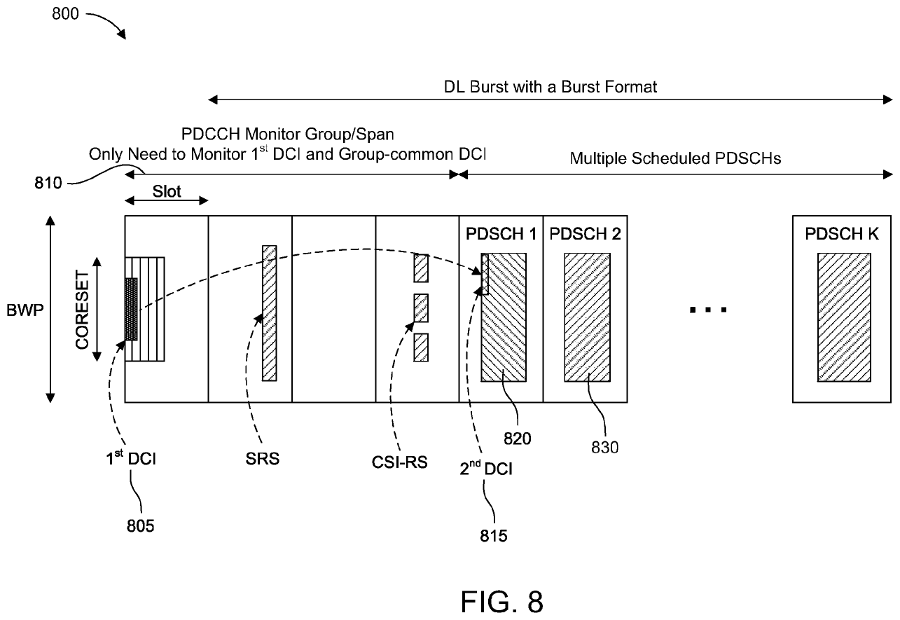

In some systems, e.g., 5G NR, PDCCH monitoring and/or PDCCH monitoring capabilities (e.g., a maximum number of PDCCH blind decodes, a maximum number of non-overlapped control channel elements) are defined in PDCCH monitoring spans (or groups), which may correspond to a certain time duration such as a number of symbols or a number of slots. Turning to the FIG. 8 diagram of a DL burst 800, the 1^{st} DCI 805 may be received within a first PDCCH monitoring span 810, while the 2^{nd} DCI 815 may be received after the first span 810, e.g., in a second span or in a later time slot. In one example, the 2^{nd} DCI 815 may be multiplexed in a first PDSCH 820 that is received after the first span 810. In another example, the 2^{nd} DCI (not shown) may be received in a second PDCCH 830 after the first span 810. The WTRU may monitor other CORESET(s) and/or search space sets within the first PDCCH monitoring span 810 as well, such as for broadcast PDCCH or group-common PDCCH.

If the 2^{nd} DCI is received in a 2^{nd} PDCCH, the 2^{nd} PDCCH may be in the first span 810 or in a subsequent span. Note that even though various examples herein may assume OFDM as an exemplary waveform, the examples are equally applicable to single-carrier waveforms, such as single-carrier FDMA.

A DL burst may be scheduled by a first DCI carried by a first PDCCH. A semi-persistent DL burst may be activated by a first DCI carried by a first PDCCH. Once a semi-persistent DL burst is activated by a first DCI, the semi-persistent DL burst may be deactivated by another DCI carried by another PDCCH.

In various embodiments, the first DCI may convey one or more of the following pieces of information, e.g., by including a corresponding field or by implicit indication through another field or combination of fields. The pieces of information, e.g., in individual fields, may include any of the following, are described in more detail below:
DL burst format indicator
DL burst indicator
SRS request
CSI-RS indicator
Activation/deactivation of semi-persistent SRS
Activation/deactivation of semi-persistent CSI-RS.
HARQ-related information for the one or more PDSCH
Indication of one or more PUCCH resources.
Resource allocation (RA) for one or more PDSCH.
Modulation and Coding Scheme (MCS)
Antenna port(s)
QCL information
2^{nd} DCI information
BWP and cell/carrier information.

A DL burst format indicator may indicate one out of multiple DL burst formats. A burst format may correspond to the structure of the burst, e.g., which components are included, their relation in time, etc. Multiple DL burst formats may be configured, as further described below in conjunction with configuration, activation, and triggering of DL Bursts.

A DL burst indicator (or trigger) may indicate that a DL burst is scheduled or activated. If not, the DCI may be used for other purposes, e.g., a legacy operation such as scheduling a single PDSCH, requesting an AP SRS, etc.

A DL burst format indicator and/or DL burst indicator may indicate one or more of the other parameters/fields discussed here. For example, a DL burst format indicator may convey TDRA, SRS request, CSI-RS indicator, etc.

An SRS request (or trigger, or indicator) may request a WTRU to transmit an SRS resource in the DL burst. The request may also convey various SRS parameters. SRS may be triggered without an explicit SRS request, e.g., an SRS request may be a part of the DL burst format indicator or the PDSCH time domain resource allocation.

A CSI-RS indicator (or trigger) may indicate that one or more CSI-RS resources and/or CSI-RS resource sets, e.g., TRS, CSI-RS for beam management, or CSI-RS for CSI acquisition, are included in the DL burst. CSI-RS may be triggered without an explicit CSI-RS trigger, e.g., a CSI-RS indicator may be a part of the DL burst format indicator or the PDSCH time domain resource allocation.

The first DCI may also activate/deactivate SP SRS or SP CSI-RS, which may be part of the DL burst. For example, the first DCI may activate SP SRS or SP CSI-RS, with deactivation after the DL burst, e.g., automatic deactivation after a certain time instance in or after the DL burst or by explicit deactivation in a DCI after the first DCI.

Furthermore, the corresponding HARQ-related information for the one or more PDSCH transmissions may be indicated. This may include indication of HARQ process number(s) for the one or more PDSCH transmissions, for instance by incrementing the HARQ process number for each subsequent PDSCH transmission in the burst. Alternatively, the DCI may include as many HARQ process number fields as transport blocks transmitted in the DL burst, which may be less than the number of PDSCH transmissions (e.g., if a transport block is repeated in multiple PDSCH transmissions or if a rule to derive the HARQ process numbers for multiple transport blocks in the DL burst from one HARQ process number in a DCI is applied), or higher than the number of PDSCH transmissions (e.g., if a PDSCH transmission carries multiple transport blocks), or equal to the number of PDSCH transmissions. Alternatively, the HARQ-related information may include a bitmap with length equal to the number of transport blocks carried in the DL burst, in which a first bit value (e.g., ‘1’ or ‘0’) indicates that a TB for the corresponding HARQ process is included in the DL burst. In another case, both a number and a bitmap are included. The bitmap may indicate the HARQ processes for the PDSCH transmissions in the burst, while the number may indicate the HARQ process number for the first PDSCH transmission. The subsequent PDSCH transmission may use the next (greater or smaller) HARQ process number that is set in the bitmap, etc. The number may be a HARQ process number or an index among the HARQ the process numbers set by bitmap, e.g., represented by log₂ [the number of PDSCH transmissions] bits.

HARQ-related information may include new data indicators (NDI) and redundancy versions (RV) of the TBs of the scheduled PDSCH transmissions, e.g., as in NR Rel-17 as discussed above.

The first DCI may indicate one or more PUCCH resources that may be used for HARQ-ACK feedback from the PDSCH transmissions, e.g., by one or more PUCCH resource indicators and/or one or more PDSCH-to-HARQ feedback timing indicators.

Time/frequency (t/f) domain resource allocation. One or more PDSCH transmissions may be scheduled by the first DCI. The first DCI may indicate time domain resource allocation (TDRA), at least partly, and/or frequency domain resource allocation (FDRA). In 5G NR, the TDRA field selects a row (entry) in a configured TDRA table (list). A row in the table may include TDRA for one or more PDSCH(s). The TDRA for a PDSCH may include a time-slot offset between DCI and PDSCH (k0), a PDSCH mapping type, a SLIV, and a repetition number.

The TDRA in a DCI in a DL burst may correspond to one or more start and length indicator (SLIV) for the time domain allocation of PDSCH (e.g., a symbol allocation in a time slot) and/or time-slot offset(s) between the DCI and time slot(s) containing PDSCH, similar to 5G NR. The TDRA in the 1^{st} DCI may be the TDRA for the 1^{st} PDSCH. The TDRA for subsequent PDSCH(s) may be in the 2^{nd} DCI (or subsequent DCIs).

If a PDSCH is scheduled/activated by a 1^{st} DCI, it may be beneficial to be able to adjust the number of PDSCH REs in the 2^{nd} DCI, e.g., based on an MCS adjustment in the 2^{nd} DCI or based on the most recent DL buffer status. Therefore, the TDRA in the 1^{st} DCI may include a starting time slot and symbol of the 1^{st} PDSCH. The length (e.g., number of symbols and/or number of slots) of the 1^{st} PDSCH may be included in the 2^{nd} DCI. Alternatively, the 2^{nd} DCI may adjust a preliminary length indicated in the 1^{st} DCI, e.g., by a SLIV or by a length offset that may be added to the preliminary length.

Furthermore, the TDRA in the 2^{nd} DCI may include the starting time slot and symbol of the 2^{nd} PDSCH, and so on with any subsequent DCIs and PDSCHs. In various examples, a TDRA table is extended to include or be linked with more signals/channels in a DL burst, e.g., for more efficient control signaling. A TDRA table row may include information on or be linked with one or more SRS and/or CSI-RS, in addition to the one or more PDSCH. The TDRA and TDRA field may be a part of a DL burst format indicator, or vice versa. The TDRA table (or DL burst format table) configuration, etc., is discussed herein.

Modulation and coding scheme (MCS). The 1^{st} DCI may convey one or more MCSs for the PDSCH(s). The one or more MCSs may apply to one, a subset of, or all PDSCHs in the burst. For example, the DCI indicates 1-2 MCS that apply to the 1-2 TBs of each PDSCH in the burst. In another example, the DCI conveys an MCS per TB in the burst. In some cases, the one or more MCSs are partial MCSs or preliminary MCSs, with the 2^{nd} (or subsequent) DCI(s) conveying remaining partial or adjusted MCSs. In some cases, the 1^{st} DCI also conveys an MCS applicable to the 2^{nd} DCI, which may be the same or separate from an MCS for a corresponding PDSCH.

Antenna Port(s). The 1^{st} DCI may convey the PDSCH and PDSCH DMRS antenna port(s), including the number of antenna ports. In some cases, the 1^{st} DCI may indicate PDSCH DMRS antenna port(s), while the 2^{nd} DCI may convey the PDSCH antenna ports, which may be a subset of the PDSCH DMRS antenna ports, for instance.

QCL Information. The 1^{st} DCI may convey QCL information (including QCL regarding various temporal, frequency, and spatial parameters) for the various signals/channels in the burst, for example in the form of one or more TCI fields. A TCI field may correspond to one or more TCI states, which may provide information of a QCL source RS for one or more DL signals/channels and/or one or more UL signals/channels in the burst.

The QCL information may include one or more spatial source RS for the SRS in the burst. For example, a spatial source RS may be applicable to an SRS resource or to an SRS resource set. The QCL information may include one or more QCL source RSs for the CSI-RS in the burst. The QCL information may also include QCL information for the one or more PDSCHs, for example QCL source RS(s). In some cases, one or more CSI-RS resources in the burst may serve as QCL source for the one or more PDSCHs. For example, a TRS in the burst may serve as a QCL source for each PDSCH in the burst. In another example, a CSI-RS for beam management in the burst may serve as spatial QCL source for one or more PDSCHs in the burst.

2^{nd} DCI Information. The 1^{st} DCI may include information regarding a 2^{nd} DCI, in addition to what has been discussed above, such as DCI format, which may include CRC size, exact time-frequency location of a 2^{nd} PDCCH, beta offset (if the DCI is multiplexed with a PDSCH), presence of 2^{nd} DCI, etc. The 2^{nd} DCI information may include an indication of CORESET (e.g., CORESET ID) and/or search space set (e.g., search space set ID) in which the WTRU may expect the 2^{nd} DCI. In some cases, the 1^{st} DCI includes information regarding a 2^{nd} DCI such that a small number of blind decodes may still be needed for the 2^{nd} DCI. For example, a small set of time-frequency locations, PDCCH candidate indices, aggregation levels, etc., may be indicated.

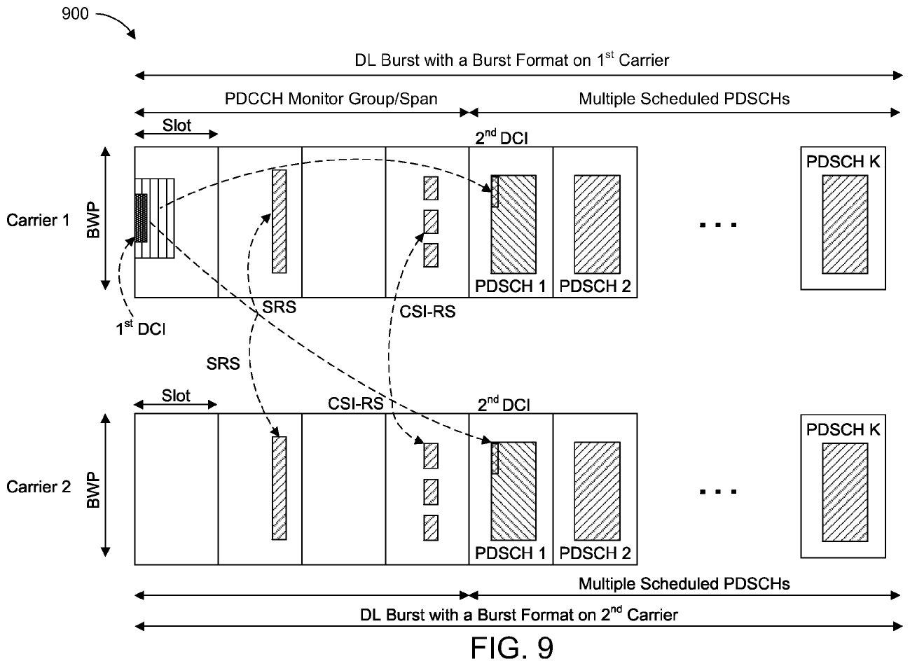

BWP and Cell/Carrier Information. The 1^{st} DCI may schedule/activate a DL burst on another BWP and/or another serving cell (or carrier). For example, the DCI may include a BWP indicator, and a BWP other than the active BWP (on which the 1^{st} DCI is received) may indicate a switch to the indicated BWP for reception of the burst. The DCI may also include a carrier indicator (or serving cell indicator), which may indicate that the burst is scheduled/activated on another carrier/cell. Turning to FIG. 9, an example of multiple carrier DL bursts 900 are shown. In some cases, the 1^{st} DCI may schedule DL bursts on multiple BWPs and/or serving cells (or carriers).

5G NR supports the use of a single DCI to schedule one or multiple PDSCH(s). The single DCI conveys the information necessary to receive the one or more PDSCH. However, in the DL burst, some DCI information may depend on measurements on the SRS in the DL burst, for example MCS for PDSCH. Therefore, the control information may be split between the 1^{st} DCI and subsequent DCI(s) in the DL burst. The 2^{nd} DCI is used as an example, but similar information may be conveyed by subsequent DCIs, such as a 3rd DCI, a 4^{th} DCI, etc. In some cases, however, a single DCI (the 1^{st} DCI) schedules/activates a DL burst and no subsequent DCIs are part of the burst.

In some embodiments, the 2^{nd} DCI may include one or more of the following information:
MCS information
Antenna port(s)
FDRA
QCL information
SRS information
Pre-emption and cancellation indication
Subsequent DCI information

It may be suitable to convey MCS information in the 2^{nd} DCI since it may take the SRS measurements into account. The MCS may be applicable to one or more PDSCH(s). The complete MCS information may be carried in the 2^{nd} DCI. Alternatively, a partial or adjusted MCS may be carried in the 2^{nd} DCI.

For example, the 1^{st} DCI may convey a range of MCS while the 2^{nd} MCS may convey an MCS within the range. For instance, the 1^{st} DCI may convey a modulation scheme (e.g., QPSK, 16-QAM, etc.) while the 2^{nd} DCI may convey the code rate to use together with the modulation scheme. For another example, the 1^{st} DCI may convey a MCS table while the 2^{nd} DCI may convey the exact MCS to use within the MCS table. Such a division may be beneficial for the WTRU receiver timeline since PDSCH demodulation may be completed before the 2^{nd} DCI has been decoded, assuming that the PDSCH demodulation operation can be performed knowing only the modulation format, which is obtained after decoding the 1^{st} DCI. After decoding of the 2^{nd} DCI and obtaining the code rate, the PDSCH may be decoded, e.g., based on demodulated soft bits.

In another example, the 2^{nd} DCI conveys an MCS offset that may be used to adjust the MCS indicated by the 1^{st} DCI. For example, a 3-bit MCS offset may adjust the MCS level in the 1^{st} DCI by −4, −3, −2, −1, 0. +1, +2, or +3. The MCS offset may adjust the MCS level not below a minimum MCS level and not above a maximum level.

In another example, the 2^{nd} DCI conveys a rate matching parameter that applies to one or more PDSCHs, e.g., a PDSCH in which the DCI is multiplexed, the next PDSCH, or one or more subsequent PDSCHs. The rate matching parameter may indicate one or more rate matching patterns from a configured set of rate matching patterns. The DCI may also convey to which one or more PDSCH transmissions the rate matching parameter applies.

In a further example, the 2nd DCI conveys a puncturing parameter that applies to one or more PDSCHs, e.g., a PDSCH in which the DCI is multiplexed, the next PDSCH, or one or more subsequent PDSCHs. The puncturing parameter may indicate one or more puncturing patterns from a configured set of puncturing patterns. The DCI may also convey to which one or more PDSCH transmissions the puncturing parameter applies.

In some cases, the 2nd DCI may convey PDSCH DMRS and/or PDSCH antenna ports. In the case that the 2nd DCI is carried in a PDCCH, the 2nd DCI may indicate both PDSCH DMRS and PDSCH antenna ports, e.g., as the indication in 5G NR.

In another example, e.g, if the 2nd DCI is multiplexed with the PDSCH or if it's received in a separate PDCCH, the 1st DCI may indicate the PDSCH DMRS antenna ports. The 2nd DCI may indicate if the set of PDSCH antenna ports is the same as the PDSCH DMRS antenna ports, or if it's a subset of the PDSCH DMRS antenna ports. For instance, the 2nd DCI may provide a chance for the network to reduce the PDSCH transmission rank at a late stage, for example due to the latest SRS measurement, which may show a channel change, e.g., a disruption of a significant path, or due to multi-user scheduling

A field of 1 or more bits may indicate to the WTRU if the transmission rank is reduced or not. If not, the PDSCH uses the same antenna ports as the PDSCH DMRS. For a 1-bit field, rank reduction may mean rank reduction by one or rank reduction to rank 1. In some cases, the lowest numbered PDSCH DMRS antenna ports may be used for the PDSCH reception. Alternatively, the 2nd DCI may indicate a subset of the antenna ports for PDSCH DMRS to be used for PDSCH. If multiple PDSCH DMRS antenna ports have been indicated by the 1st DCI, the 2nd DCI itself may be received on a particular antenna port, e.g., the PDSCH DMRS antenna port with lowest index, or the PDSCH DMRS antenna port that is also used for phase-tracking RS. Alternatively, the DCI may be duplicated/repeated across the multiple PDSCH DMRS antenna ports.

According to various embodiments, the 2nd DCI may convey FDRA information for one or more PDSCH(s). The 2nd DCI may adjust the FDRA indicated in the 1st DCI or provide a new FDRA that may be independent of an FDRA indicated in the 1st DCI. For example, the 2nd DCI FDRA may adjust an edge RB of the 1st DCI FDRA, e.g., the starting RB or end RB. The 2nd DCI FDRA may include a positive or negative RB offset that may be added to the edge RB number, thereby increasing or decreasing the PDSCH bandwidth. If the 2nd DCI is multiplexed in a PDSCH and it is located in (or near) an edge RB, the 2nd DCI FDRA may adjust the other edge. This may be useful if the FDRA of the PDSCH in which the 2nd DCI is multiplexed is adjusted. If the 2nd DCI FDRA provides a new FDRA, it may be limited to include the RBs that carry the 2nd DCI.

The WTRU may know in advance, e.g., by configuration, indication, or by a rule in a specification, before receiving the 2nd DCI (and the corresponding PDSCH) a maximum set of RBs that the 2nd DCI can indicate, e.g., a maximum bandwidth or a maximum RB offset magnitude. This may help WTRUs to avoid receiving DL signals/channels with unnecessarily large receiver bandwidth.

The 2nd DCI may indicate QCL information, e.g., one or more QCL source RS (and corresponding QCL types) for the DMRS of one or more PDSCHs, or one or more TCI states for the DMRS of one or more PDSCHs. The QCL information may be in the form of a TCI field. An indicated QCL source RS may be a signal in the DL burst, e.g., an SRS resource or a CSI-RS, e.g., TRS or CSI-RS for beam management.

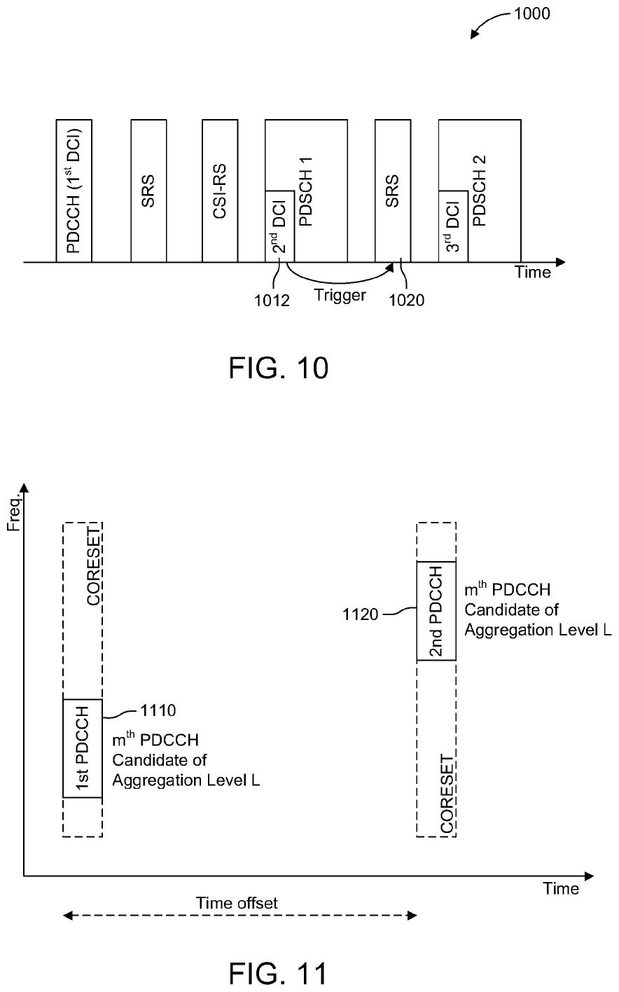

Turning to FIG. 10, the 2nd DCI 1012 may trigger or cancel a subsequent SRS transmission 1020 in the burst 1000. The 2nd DCI 1012 may activate or deactivate a semi-persistent (SP) SRS. Furthermore, the 2nd DCI 1012 may indicate or update a spatial QCL reference RS for a subsequent SRS transmission, e.g., a previous CSI-RS in the burst, for example by including a corresponding TCI field in the 2^{nd} DCI 1012.

The 2^{nd} DCI (or a subsequent DCI) may include a pre-emption indication for past or upcoming transmissions (e.g., PDSCH, PDCCH, PUSCH, PUCCH, CSI-RS, or TRS), in which some resources are indicated as pre-empted. For a past transmission, the WTRU may assume that the intended signal/channel was not transmitted on the pre-empted resources, for example resulting in PDSCH puncturing. For an upcoming transmission, the WTRU may ‘assume’ that the intended signal/channel will not be transmitted on the pre-empted resources, for example resulting in PDSCH puncturing. Furthermore, upcoming DL or UL transmissions may be cancelled, for example an upcoming PDSCH transmission or an upcoming SRS transmission may be cancelled. One difference between pre-emption and cancellation may be that pre-emption refers to a set of resources (e.g., RBs and/or symbols), i.e., that the resources are not used for the original transmission, while cancellation may refer to the cancellation of the transmission of a channel or a signal.

The 2^{nd} DCI may include information on subsequent DCI(s) in the burst. The information may be the same as, or otherwise similar to, the information in the 1^{st} DCI regarding the 2^{nd} DCI, as described above. In some cases, the 2^{nd} DCI is transmitted in a 2^{nd} PDCCH.

For timely CSI application, it may be beneficial to reduce the delay between transmission of a 2^{nd} DCI and a subsequent PDSCH. A major part of DCI decoding delay in state-of-the-art systems may be due to significant blind decoding efforts of several different PDCCH candidates with different aggregation levels, DCI formats, etc. To reduce the DCI decoding delay (and at the same time the WTRU effort, power consumption, etc.), it may be beneficial to reduce the amount of blind decoding required for the 2^{nd} DCI. In some cases, the time-frequency location, aggregation level, DCI format, etc., are known by the WTRU after decoding the 1^{st} DCI, such that blind decoding is not performed. A drawback may be reduced PDCCH transmission flexibility. However, this drawback may be minor since the flexibility of the 1^{st} PDCCH may be maintained.

In various examples, the 2^{nd} PDCCH is received in the same CORESET as the 1^{st} PDCCH. This may have various implications such that the QCL source(s), CORESET frequency resource, CORESET duration, CORESET pool index, etc., is the same for the 2^{nd} and 1^{st} PDCCH. The 1^{st} PDCCH may be received in a 1^{st} search space set that is associated with the CORESET. The 2^{nd} PDCCH may be received in a 2^{nd} search space set that is associated with the same CORESET or that is linked with the 1^{st} search space set. In some cases, some time-domain properties of the 2^{nd} search space set, e.g., periodicity, time-slot offset or symbols within a time-slot, may be configured as part of the DL burst configuration. The 2^{nd} search-space set may be aperiodic and triggered upon detection of the 1^{st} DCI. The 2^{nd} search space set may be semi-persistent and activated upon detection of the 1^{st} DCI.

In some cases, various parameters of the 1^{st} PDCCH, which carried the detected 1^{st} DCI, and the 1^{st} DCI are used also for the 2^{nd} PDCCH and 2^{nd} DCI, for example one or more of the following:
The set of resource elements (e.g., control channel element (CCE) indexes, or resource element groups (REGs)), e.g., in relation to the first CORESET symbol or in relation to the first symbol in the time slot.
PDCCH candidate index
Aggregation level
DCI payload size
DCI format
DCI CRC size
Precoder granularity
TCI state(s)
PDCCH DMRS scrambling parameter(s)
CORESET pool index

In various cases, the DCI format of the 2nd DCI may be different from the DCI format of the 1st DCI. In some cases, it may be the same. The slot and starting symbol of the 2nd PDCCH may be known to the WTRU after decoding the 1st DCI. For example, the slot and starting symbol of the 2nd PDCCH may be configured as part of a DL burst format configuration, and the 1st DCI may indicate the start of the DL burst in relation to the time of the 1st PDCCH. A time offset between 1st and 2nd PDCCH may be a combination or sum of a time offset between the 1st PDCCH and the DL burst, and the time offset of the 2^{nd} PDCCH within the DL burst. The 1^{st} DCI may also convey scheduling information for the 2^{nd} PDCCH (or associated CORESET and/or search space set), which may include time- and/or frequency offset values.

Note that if the PDCCH candidate index of the 1^{st} and 2^{nd} PDCCH is the same, the sets of resource elements (or CCE indexes or REGs) may be different, e.g., if the two PDCCH are in different time slots or in different monitoring time spans. An exemplary illustration is shown in FIG. 11, in which the 1^{st} DCI is received in a 1st PDCCH 1110 in a CORESET on the mth PDCCH candidate of aggregation level L, and the 2nd DCI is received in a 2nd PDCCH 1120 in the same CORESET, also on the mth PDCCH candidate of aggregation level L, which corresponds to a different set of REs. The first PDCCH/DCI 1110 may be subject to blind decoding within the corresponding CORESET and search space set, like in legacy systems. The 2^{nd} PDCCH/DCI 1120, however, may be directly decoded without the need for blind decoding, since its parameters (e.g., candidate index, aggregation level, etc.) may be given once the 1st DCI has been correctly decoded. Note that FIG. 11 does not show any signals/channels of the DL burst other than the 1st and 2nd PDCCH.

In some cases, the 1st PDCCH is received in a 1st CORESET and 1st search space set, and the 2nd PDCCH may be received in a 2nd CORESET.

The 2nd CORESET may be in the same BWP as the 1st CORESET, a different BWP but in the same serving cell, as the 1st CORESET, or in a different serving cell (and therefore also in a different BWP) than the 1st CORESET.

In some cases, the 2^{nd} PDCCH is received in a 2^{nd} search space set. In some cases, a search space set for the 2^{nd} PDCCH is not configured or defined. The 1^{st} and 2^{nd} search space sets may be linked through configuration. After decoding the 1^{st} DCI, the WTRU may determine the parameters for the 2^{nd} PDCCH/DCI from the search space set (the 2^{nd} search space set) linked to the search space set on which the 1^{st} DCI was received, and the corresponding CORESET (the 2^{nd} CORESET).

In some cases, the 2^{nd} CORESET (e.g., its ID) and/or 2^{nd} search space set (e.g., its ID) is configured in the DL burst format, e.g., which may be included in the configuration of a certain BWP or cell.

In the case in which the 1^{st} and 2^{nd} CORESETs are separate (e.g., separately configured or if one or more of parameters of the 2^{nd} CORESET may be derived from the parameters of the 1^{st} CORESET while other parameters may be fixed), the PDCCH candidate index and the aggregation level of the 2^{nd} PDCCH may still be the same as for the 1^{st} PDCCH. This may be achieved by causing the two CORESETs to have the same configuration, at least in some respects, such that the same PDCCH candidate index and aggregation level also exist in the 2^{nd} CORESET. This is similar to the solution adopted for multi-TRP PDCCH repetition in 5G NR Rel-17, in which a DCI is repeated in a PDCCH candidate across two linked search space sets and CORESETs. Here, the 2^{nd} DCI is not a repetition of the 1^{st} DCI. Furthermore, the location in time of the 2^{nd} PDCCH, e.g., the time slot and/or symbol, might not be fixed in time, but may depend on the information in the 1^{st} DCI. The PDCCH repetition may occur within a time slot in the same BWP.

An enhancement to the case with a 1^{st} and a 2^{nd} CORESET is to allow a different number of PDCCH candidates for a certain aggregation level, in particular fewer candidates in the 2^{nd} CORESET than in the 1^{st} CORESET. For example, if the 1^{st} DCI is decoded in PDCCH candidate m1 on aggregation level L in the 1^{st} CORESET, the 2^{nd} PDCCH may be received in PDCCH candidate m2 on aggregation level L, with m2=mod(m1, M2), where M2 is the number of PDCCH candidates on aggregation level L in the 2^{nd} CORESET.

The frequency domain resource allocation (FDRA) of the 2^{nd} CORESET may be explicitly configured in the CORESET configuration, as in legacy 5G NR. In one example, the FDRA of the 2^{nd} CORESET is indicated, at least partly, in the 1^{st} DCI. For example, the CORESET FDRA may be based on the PDSCH FDRA, for instance such that overlap between CORESET and PDSCH FDRA may be achieved. This may be beneficial for various reasons, for example improved channel estimation, reduced receiver bandwidth, etc. For example, if the CORESET bandwidth is less than or equal to the PDSCH bandwidth, then the CORESET FDRA may be adjusted such that it overlaps with the PDSCH bandwidth, e.g., by setting the lowest CORESET resource block to be aligned with the lowest PDSCH resource block, or by setting the highest CORESET resource block to be aligned with the highest PDSCH resource block, or by setting the center frequency of the CORESET to be aligned with the center frequency of the PDSCH. If the CORESET bandwidth is greater than the PDSCH bandwidth, then the configured CORESET FDRA may be used. Alternatively, the configured CORESET starting RB is adjusted with the minimum number that achieves full overlap in frequency with the scheduled PDSCH.

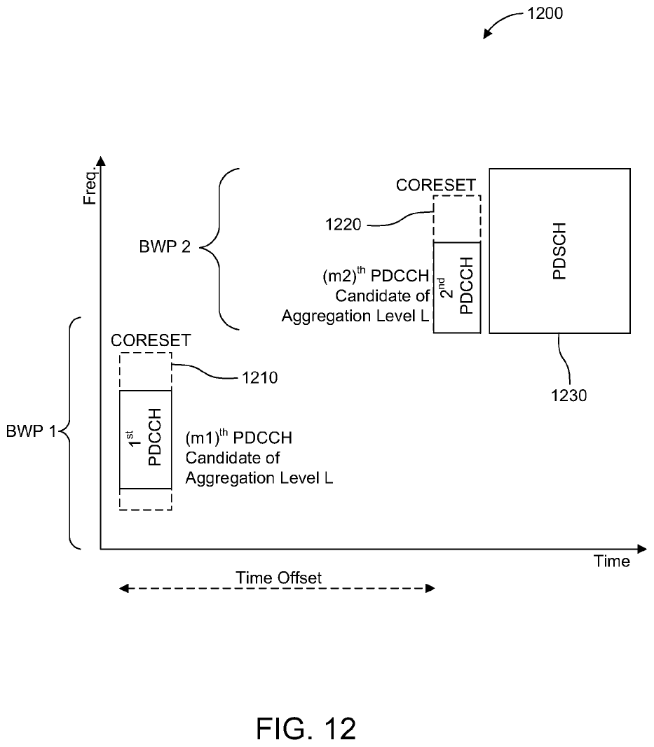

FIG. 12 shows an example 1200 in which the 2^{nd} CORESET 1220 is separate from the 1^{st} CORESET 1210. The WTRU decodes the PDCCH candidate m2 in the 2^{nd} CORESET 1220 (for aggregation level L), since it decoded the 1^{st} DCI in PDCCH candidate m1 in the 1^{st} CORESET 1210 (for aggregation level L) based on a rule/relation between m1 and m2, for example m2=m1, or m2=mod (m1, M2). The exemplary illustration also shows the 2^{nd} CORESET 1220 overlapping in frequency with the scheduled PDSCH 1230, which may be achieved by methods described above. The exemplary illustration also shows cross BWP scheduling of the DL burst. Note that for clarity, FIG. 12 might not show all signals/channels of the DL burst.

In some cases, the 2^{nd} DCI is multiplexed with a PDSCH, e.g., the first PDSCH or in one or more subsequent PDSCH(s). Various methods described for when the 2^{nd} DCI is transmitted in a 2^{nd} PDCCH may also be applied for the case that the 2^{nd} DCI is multiplexed in a PDSCH. The 2^{nd} DCI may be separately encoded, modulated, and multiplexed in the PDSCH in ways similar to how the 2^{nd} stage sidelink control information (SCI) is multiplexed in the physical sidelink shared channel (PSSCH) as mentioned previously. However, the functionality of the 2^{nd} DCI may be different from the functionality of the 2^{nd} stage SCI. In various embodiments, the 2^{nd} DCI aims to provide the most recent control information for the subsequent PDSCH(s), such as up-to-date MCS and antenna ports based on just measured SRS, and other adjustments to PDSCH(s) such as cancellation. A purpose of the 1^{st} and 2^{nd} stage SCI includes providing information mostly relevant to many WTRUs in the 1^{st} stage SCI (such as resource reservation) while the 2^{nd} SCI provides information relevant to the WTRU(s) intended to receive the PSSCH.

The encoding, modulation, multiplexing, etc., of the 2^{nd} DCI into PDSCH may also follow the principles of multiplexing of uplink control information (UCI) in PUSCH in 5G NR. This may be useful for instance to avoid simultaneous transmission of PUCCH and PUSCH.

In case of a multi-layer PDSCH, the single-layer DCI may be transmitted on one or the layers, e.g., on the lowest numbered antenna port, or the PDSCH DMRS antenna port that is also used for phase-tracking RS. Alternatively, the DCI symbols may be duplicated and transmitted on each of the antenna ports. The latter approach is used in 5G NR for control information multiplexing in a shared channel.

In certain embodiments, it may be advantageous to multiplex the DCI early in the PDSCH, e.g., in the first symbol or the first few symbols, in order to allow DCI decoding completion prior to PDSCH decoding. It may also be beneficial to multiplex the DCI in the RE close to the DMRS for better channel estimates. An advantage of multiplexing the 2 DCI in the PDSCH rather than in a separate PDCCH may be more simple and efficient resource allocation since no separate resources for PDCCH are used. Furthermore, multiplexing in the PDSCH may compress the timeline since the information in the DCI may be encoded and modulated late in the transmit processing pipeline.

Sounding Reference Signal (SRS) in DL Burst. A DL burst may include WTRU transmission of one or more SRS resources for the purpose of CSI acquisition. Depending on various factors such as WTRU mobility, carrier frequency, deployment scenario, etc, the CSI obtained from an SRS measurement may be valid during a certain time duration, e.g., the channel coherence time. If the duration of CSI validity is longer than the DL burst duration, it may be sufficient with one round of SRS transmission in the DL burst, e.g., in the beginning of the DL burst or even before the DL burst. However, if the duration of the CSI validity is shorter than the duration of the DL burst, multiple rounds of SRS transmission throughout the DL burst may be required. Furthermore, the CSI obtained from an SRS measurement may be valid within a certain bandwidth, e.g., the bandwidth spanned by the SRS, or a coherence bandwidth around a sub-carrier carrying SRS, or the bandwidth spanned by the SRS plus a coherence bandwidth around the edges of the SRS.

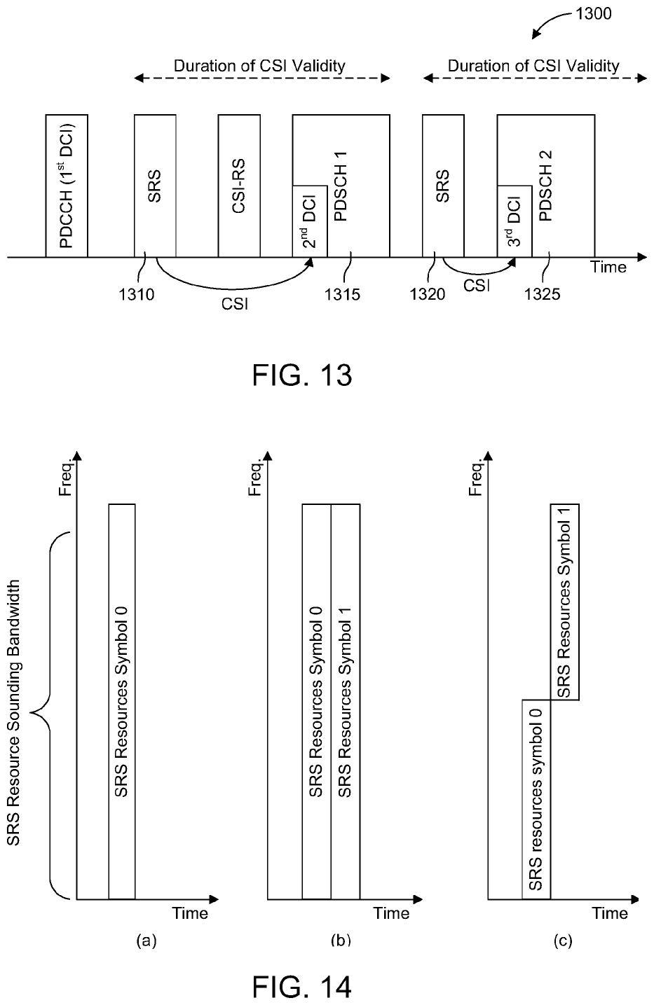

Referring to FIG. 13, an illustration of multiple rounds of SRS transmission are shown in a DL burst 1300. A round of SRS transmission may correspond to the transmission of one or more SRS resources for CSI acquisition, typically concentrated in time, e.g., a few symbols or a time slot. The SRS resources may correspond to one or more SRS resource sets, for instance an SRS resource set for antenna switching. FIG. 13 shows the DL burst 1300 with two rounds of SRS transmissions 1310, 1320, such that the network can acquire valid CSI for both the first PDSCH 1315 and second PDSCH 1325. The CSI acquired at the network may be reflected in the information carried in the 200 and 3rd DCI, for example in the indicated MCS(s) for PDSCH 1 1315 and PDSCH 2 1325.

The position and/or presence of the SRS resources in the DL burst may be configured (see below) or indicated, for example by MAC CE or DCI, or a combination. In case of DCI triggered SRS, one or more rounds or SRS may be triggered by the 1^{st} DCI. In some cases, the first round of SRS may be triggered by the 1^{st} DCI, while subsequent round(s) of SRS, if any, may be triggered by the subsequent DCI(s), as illustrated FIG. 13.

In some cases, the presence of subsequent round(s) of SRS may impact the bundling of PDSCH ACK/NACKs, if ACK/NACK bundling is configured. For example, the ACK/NACKs corresponding to the PDSCH transmissions between two subsequent rounds of SRS may be bundled. If there is just a first round of SRS in a DL burst, then all ACK/NACKs in the burst may be bundled. In some cases, ACK/NACKs are bundled based on the set of PDSCHs affected by the 2^{nd} DCI, 3^{rd} DCI, etc. For example, the ACK/NACK from the PDSCH with the 2^{nd} DCI multiplexed and from the subsequent PDSCHs are bundled, while the ACK/NACK from the PDSCH with the 3^{rd} DCI multiplexed and from the subsequent PDSCHs are bundled, and so on. Such a scheme may be beneficial since the link quality (e.g., error rate, SINR or SNR) may change between subsequent SRS rounds or subsequent DCIs.

In some cases, one or more SP SRS resources may be activated by a DCI in the DL burst, e.g., the 1^{st} DCI, or by an activation MAC CE, or by an RRC message. In some cases, the SP SRS resource may be explicitly deactivated as in legacy systems. However, this may result in unnecessary overhead, since an SP SRS for CSI acquisition may be useful during a DL burst but less useful after a DL burst. Hence, an SP SRS resource may be automatically deactivated during of after the DL burst. For example, the SP SRS resource is deactivated after the last PDSCH transmission in the burst, i.e., the first SP SRS resource transmission occasion after the last PDSCH transmission in the burst is not transmitted. Alternatively, the number of SP SRS resource transmissions (or the number of slots) before deactivation may be configured, e.g., as part of a DL burst format indicator or as part of the SP SRS resource configuration.

Flexible SRS Transmission Timing. DCI-based triggering of AP SRS is supported, for example, in 5G NR (as described above in conjunction with SRS in 5G NR) with the SRS request DCI field, which has 2 bits. Since one value (‘00’) corresponds to no SRS request, only up to three different sets of AP SRS resources can be triggered by a DCI in an example. The time-slot offset between the DCI and the time-slot of the triggered SRS resource is configured and not flexible in an example. The symbol(s) in the time slot used for transmitting the SRS resource is (are) also configured and not flexible in an example. Hence, mainly due to the limited AP SRS flexibility, it can be difficult in 5G NR to combine dynamic PDSCH scheduling with variable time-slot and symbol offsets with simultaneous triggering of suitable SRS resources that keep the delay between SRS and PDSCH low.

To solve this, the SRS offset from the triggering DCI, e.g., the 1^{st} DCI, or a 2^{nd} or subsequent DCI, may follow the offset of the DL burst. If the delay between DCI and first PDSCH is short, e.g., two time slots, then the first round of SRS may be transmitted with a short delay as well, e.g., about a time slot after the DCI. If, on the other hand, the delay between the 1^{st} DCI and the first PDSCH is longer, e.g., 6 time slots, then the first round of SRS may be transmitted after a longer delay as well, e.g., after about 5 time slots.

A similar issue exists with SP SRS in 5G NR, which also has a configured time-slot offset. A solution may be to have the SP SRS time-slot offset depend on an SP PDSCH time-slot offset, for example to have the SP SRS transmission N time slots or symbols prior to an SP PDSCH, where N may be fixed (e.g., equal to 1 time slot or 21 symbols) or configurable.

Flexible SRS Transmission Bandwidth. A purpose of the SRS transmission within a DL burst is to adjust or improve the DL transmission scheme for one or more PDSCH(s) that have been scheduled on certain frequency resources, for example MCS or multi-antenna selection, precoding or beamforming. However, in 5G NR, the frequency domain properties of an SRS resource in 5G NR are often configured and not flexible. This means that it sometimes is not possible to dynamically trigger an SRS transmission only on the frequency resources that are to be used for the subsequent PDSCH transmission(s), except in special cases. Therefore, wideband SRS may be configured.

In one embodiment, the SRS transmission in a DL burst may be enhanced so that the frequency resources for SRS may be adjusted or determined based on the FDRA of a subsequent PDSCH, e.g, the immediately subsequent PDSCH, or the first PDSCH following after a certain time instance where the time instance may occur a certain time delay after the start or end of the SRS transmission, and where the time delay may be fixed of configurable by the network.

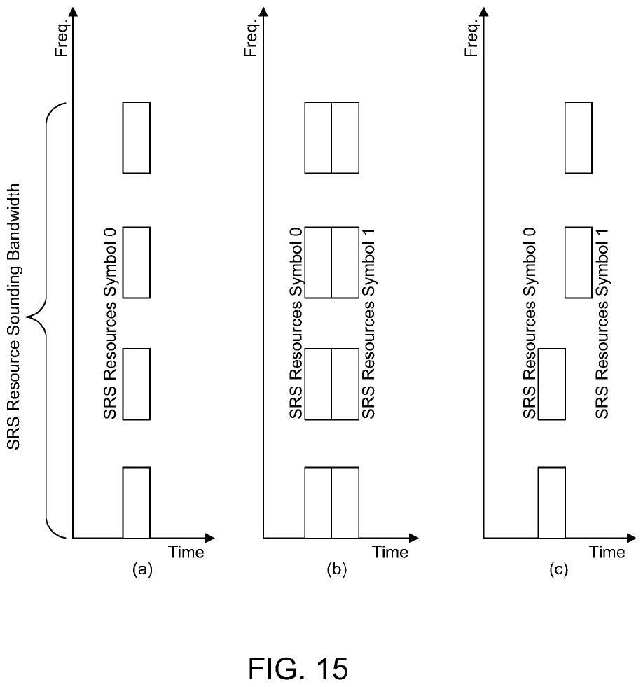

An SRS resource may span one or more symbols. An SRS resource may be configured to sound a certain sounding bandwidth. There are several ways in which an SRS resource may sound (e.g., transmit across) a certain sounding bandwidth. A few examples are as follows: each RB of the sounding bandwidth may be sounded in a single-symbol SRS resource as, for example, illustrated in FIG. 14(a); each RB of the sounding bandwidth may be repeatedly sounded in multiple symbols in a multi-symbol SRS resource (with repetition) as, for example as illustrated in FIG. 14(b); each RB of the sounding bandwidth may be sounded across multiple symbols in a multi-symbol SRS resource, where the different symbols sound different sets of RBs (frequency hopping) as, for example, illustrated in FIG. 14(c); a subset of the RBs of the sounding bandwidth may be sounded in a single-symbol SRS resource (partial sounding) as, for example, illustrated in FIG. 15(a); a subset of the RBs of the sounding bandwidth may be repeatedly sounded in multiple symbols in a multi-symbol SRS resource (partial sounding with repetition) as, for example, illustrated in FIG. 15(b); and a subset of the RBs of the sounding bandwidth may be sounded across multiple symbols in a multi-symbol SRS resource, where the different symbols sound different sets of RBs (partial sounding with frequency hopping) as, for example, illustrated in FIG. 15(c).

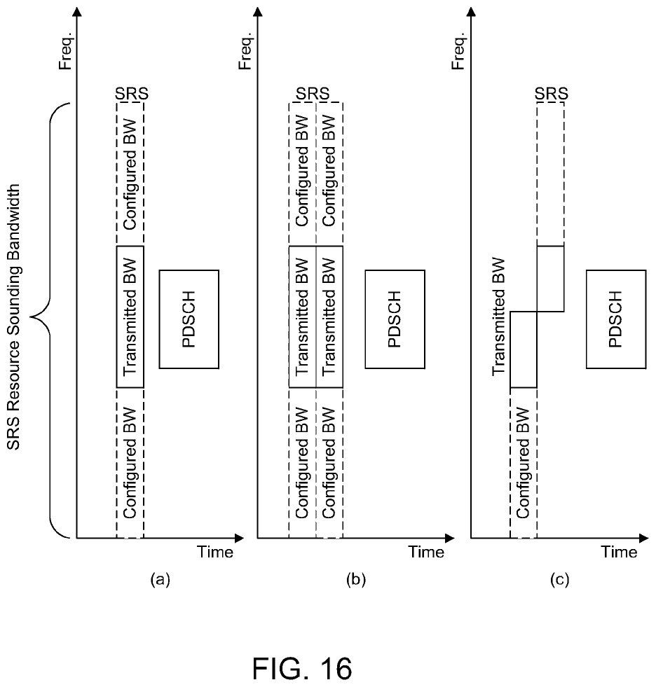

In certain embodiments, the transmission of SRS RBs can be omitted. First consider scenarios in which the scheduled PDSCH FDRA is equal to or within the configured SRS sounding bandwidth. In legacy 5G NR operation, the SRS resource would be transmitted according to its configured sounding bandwidth. This may result in unnecessarily large SRS transmission bandwidth, especially if the configured SRS bandwidth is significantly larger than the PDSCH bandwidth. SRS transmission in RBs not used for PDSCH may not be helpful for the fast adaptation within the DL burst. In one example, the WTRU may omit the SRS transmission outside the PDSCH bandwidth, as illustrated in FIG. 16, where (a)-(c) may correspond to the cases illustrated FIG. 14(a)-(c). The dashed boxes may represent configured, but not transmitted, SRS symbols/RBs, while the solid boxes represent transmitted SRS symbols/RBs, which are within the configured symbols/RBs.

In a further example, SRS transmission may also be omitted in RBs inside the PDSCH bandwidth. The RBs that can be omitted may depend on the channel coherence bandwidth characteristics. For example, SRS transmission may be omitted in one or more RBs at the edge of the PDSCH bandwidth. In another example, SRS transmission in one or more RBs within the PDSCH bandwidth, i.e., not at the edge, may be omitted. The number of omitted RBs may be based on the coherence bandwidth. The RB omission pattern, e.g., the number and/or location of omitted RBs, for instance at each edge, may be configured by the network so configuring in the WTRU. In some cases, multiple patterns may be configured by the network, and one of the patterns may be dynamically indicated, for example by a DL MAC CE or in a DCI, e.g., the 1^{st} DCI, or the 2^{nd} or a subsequent DCI. The SRS RB omission may also be configured and/or indicated as part of the DL burst format configuration and indication.

The omitted SRS transmission bandwidth may help save WTRU power, reduce interference, and increase SRS multiplexing capacity. A potential drawback is that the PDSCH (and SRS) FDRA is determined prior to the SRS-based CSI acquisition. This may lead to less gain from frequency-selective and channel-dependent scheduling. However, preliminary CSI acquisition prior to the 1^{st} DCI is not precluded. Furthermore, the gain from frequency-selective scheduling may be smaller in future systems, e.g., due to a massive number of antennas, wideband resource allocations, or line-of-sight scenarios. Systems with massive numbers of antennas (e.g., ultra-massive MIMO, holographic MIMO, or massively distributed MIMO) may experience channel hardening which, given proper multi-antenna processing, results in less variations from channel fading as is known. But wideband allocations of PDSCH may reduce the possibility of scheduling the PDSCH only on the channel peaks and avoiding the deep fades (in frequency).

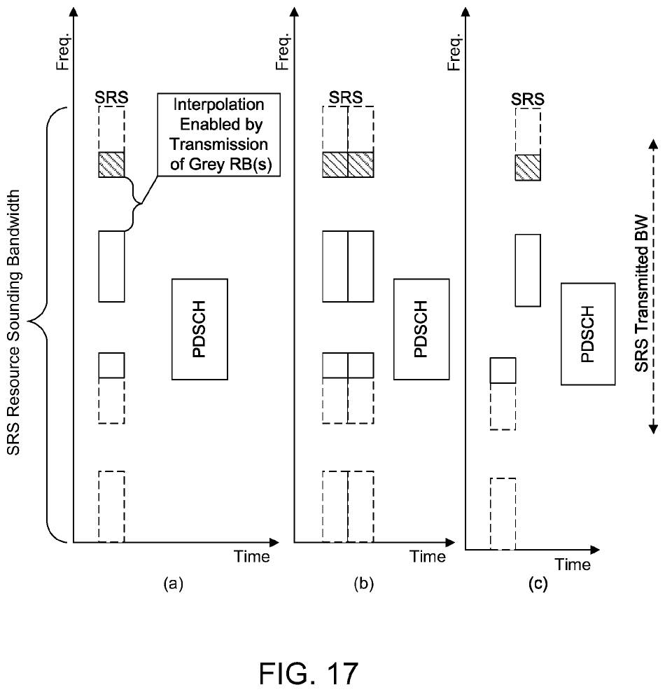

Referring to FIG. 17, for partial sounding, the transmitted SRS bandwidth may also be reduced, as illustrated in FIG. 17(a)-(c), which may correspond to the examples in FIG. 15(a)-(c). For partial sounding, the network may use interpolation to estimate the channel on the RBs that are not sounded. However, if SRS RB omission based on the PDSCH FDRA is directly applied to an SRS resource with partial sounding, the transmitted SRS resource might not provide transmitted RBs for interpolation on the edge RBs of the PDSCH. Therefore, in the case of partial sounding SRS, if no SRS is configured for an edge RB of the PDSCH, the WTRU may transmit a number of SRS RBs, e.g., one RB, or the whole block, in the next block of configured SRS RBs closest in frequency to the edge RB, as illustrated with the grey square (e.g., one or multiple RBs) in FIG. 17. Such a scheme may result in an SRS transmitted bandwidth larger than the PDSCH bandwidth, but still smaller than the configured SRS sounding bandwidth.

A DCI that triggers an SRS resource transmission, e.g., the 1^{st} DCI, 2^{nd} DCI, or a subsequent DCI, may indicate whether the transmission shall follow the configured bandwidth, or whether the WTRU shall adapt the SRS bandwidth to a scheduled PDSCH FDRA, e.g., with a 1-bit field, or a multi-bit field, or implicitly through another field such as a PDSCH TDRA field or DL burst indicator field. The WTRU may be configured per SRS resource or SRS resource set whether it is better that the WTRU apply the frequency adaptation described herein, or whether it is better that the WTRU apply the configured sounding bandwidth as in legacy systems.

In another approach, the WTRU may adjust the starting RB and/or sounding bandwidth of the SRS resource based on a PDSCH FDRA. Upon reception of an SRS trigger and a PDSCH FDRA in a DCI, e.g., in the 1^{st} DCI, 2^{nd} DCI, or a subsequent DCI, the WTRU may set the SRS starting RB to be the lowest RB of the PDSCH FDRA. However, the valid starting RB for SRS may have a different granularity than the lowest RB of a PDSCH FDRA. For example, the SRS starting RB may be adjusted in steps of 4 RBs while the PDSCH FDRA may use a granularity of 1 RB. If so, the WTRU may, for example, set the SRS starting RB to be the highest valid starting RB such that the lowest RB of the PDSCH FDRA is within the SRS sounding bandwidth. Alternatively, the SRS starting RB may be set to the lowest valid starting RB that is within the PDSCH bandwidth.

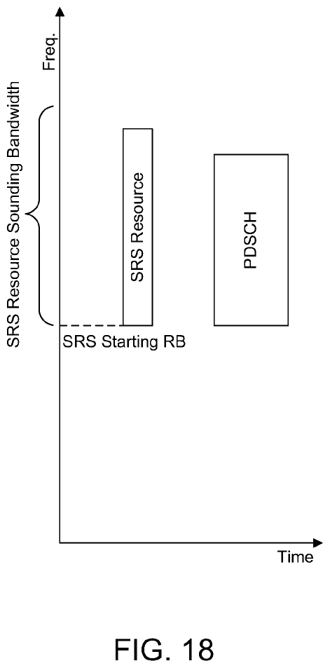

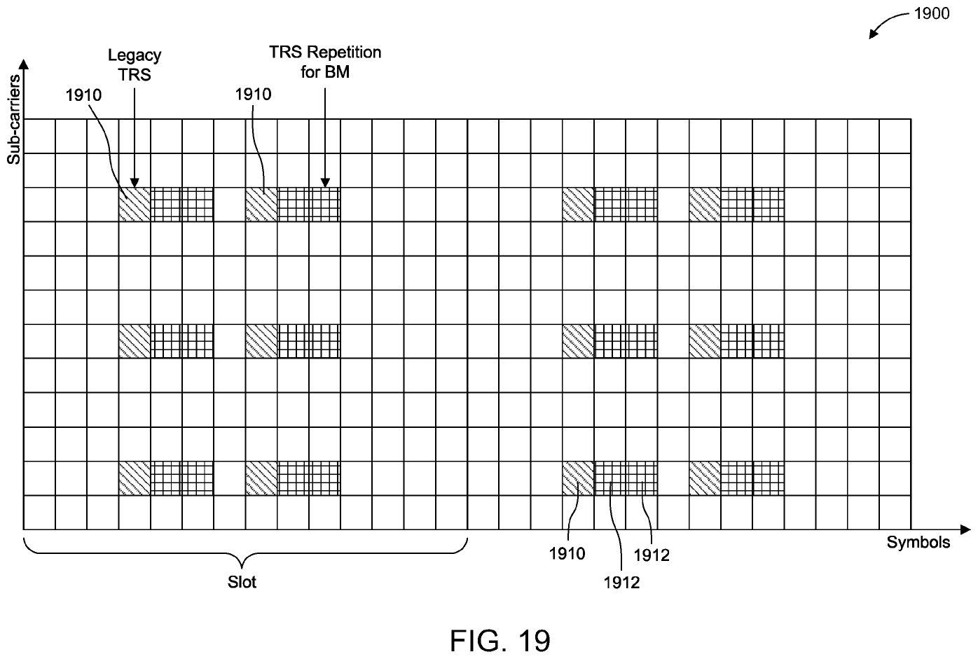

The WTRU may also set the sounding bandwidth of a triggered SRS resource to be equal to the bandwidth of the PDSCH. The sounding bandwidth granularity may be different from the PDSCH bandwidth granularity. Referring to FIG. 18, to handle such a case, for instance, the sounding bandwidth may be set to the smallest valid sounding bandwidth that is greater than or equal to the PDSCH bandwidth as illustrated. Alternatively, the sounding bandwidth may be set to the greatest valid sounding bandwidth that is smaller than or equal to the PDSCH bandwidth. In yet another alternative, the sounding bandwidth may be set to the smallest valid sounding bandwidth that results in the highest overlap between the SRS bandwidth and the PDSCH bandwidth.

The WTRU may be configured with a certain maximum SRS transmission bandwidth per SRS symbol. To increase the sounding bandwidth beyond that maximum bandwidth, the WTRU may add frequency hops in other symbols. The WTRU may be configured with a maximum number of SRS symbols in an SRS resource, that the WTRU may use for additional frequency hops. If the sounding bandwidth cannot be extended to cover the PDSCH bandwidth, even with additional hops, e.g., due to limited number of symbols, or limited WTRU SRS transmission bandwidth, which may be due to limited UL transmission bandwidth or limited UL transmit power, the WTRU may separate the hops in frequency so that the sounding bandwidth covers the PDSCH bandwidth by partial sounding.

In some cases, the WTRU may not adapt the SRS sounding bandwidth based on the PDSCH FDRA and may instead use a configured SRS sounding bandwidth. This means that the PDSCH bandwidth may be greater than the SRS sounding bandwidth. In such cases, it may be beneficial for CSI accuracy to have the WTRU transmit the SRS sounding bandwidth near the center of the PDSCH bandwidth. In other words, the WTRU may select the lowest valid SRS starting RB such that the difference between the number of PDSCH RBs below the SRS sounding bandwidth and the number of PDSCH RBs above the SRS sounding bandwidth is reduced.

In case of an SRS resource set with usage antenna switching with more Rx antennas than Tx antennas, the WTRU may transmit multiple SRS resources in different symbols from different sets of antennas. The methods above may apply to each of these SRS resources, since it may be beneficial to sound the bandwidth to be used for PDSCH for all Rx antennas.

A DL burst may include various types of CSI-RS resources and CSI-RS resource sets. For example, a DL burst may include one or more TRSs to assist receiver and demodulation performance of PDCCH(s) and/or PDSCH(s) in the burst.

In some cases, a DL burst may include CSI-RS for beam management, e.g., a CSI-RS resource set configured with repetition ‘on,’ or a CSI-RS resource set configured with the parameter ‘repetition.’ Such a CSI-RS resource set may be used by the WTRU to adjust its DL Rx beam(s), which may be useful for example if the network has adjusted its DL Tx beam(s)/precoder(s) based on SRS based measurement.

The TRS and CSI-RS for beam management may be quite similar Both signal structures are based on repetition, TRS to allow the WTRU estimate Doppler related parameters, and CSI-RS for beam management to allow the WTRU to try different DL Rx beams. The TRS, such as aperiodic (AP) TRS, may be unsuitable for DL Rx beam sweeping since the WTRU may need to keep its Rx beam fixed during the TRS symbols in order to properly estimate the tracking parameters. Furthermore, L1 measurement reports such as L1-reference signal received power (RSRP) may not be supported for TRS. If a TRS is immediately followed by a single-port CSI-RS for beam management, the WTRU may be unable to assume that the same antenna port is used, even if the TRS and CSI-RS are QCL.

Referring to FIG. 19 resource diagram 1900, for more efficient resource utilization, TRS and CSI-RS for beam management may be merged into one structure, for instance referred to as TRS with beam management, which may be based on the TRS structure 1910 in 1-2 time slots but adds a level of repetition, for example two extra repetitions 1912, following the legacy TRS 1910. The same RS values as in the legacy TRS 1910 may be repeated on the subsequent symbol(s). The TRS repetition 1912 may be added on the whole (legacy) TRS bandwidth or only on a part of the TRS bandwidth, e.g. in the PDSCH bandwidth of a subsequent PDSCH, or in the bandwidth spanned by all PDSCH transmission in the DL burst, or in a bandwidth that is configurable. The part of the TRS 1910 bandwidth may be centered or edge-aligned with a subsequent PDSCH in the DL burst. The repetitions 1920 may share the antenna port with the legacy CSI-RS resources in the TRS.

In certain embodiments, the presence of TRS repetition may be indicated to the WTRU in a DCI, e.g., in the 1^{st} DCI, 2^{nd} DCI, or a subsequent DCI. If repetition is not indicated, the WTRU may expect a legacy TRS without repetition.

In one example, a TRS with repetition may be configured by including additional CSI-RS resources in a legacy TRS, e.g., a CSI-RS resource set with the optional parameter trs-Info configured, or a CSI-RS resource set with trs-Info and an additional parameter trsRepetition. The additional CSI-RS resources in the set may have the same configuration as the legacy TRS resources, for example single-port and in the same sub-carrier, except the symbol index, which may be different. In some cases, a CSI-RS resource set comprising a TRS with repetition may be configured with the optional parameter repetition set of ‘on’.

In another example, additional CSI-RS resources may not be explicitly configured. Instead, a new optional parameter, e.g., repetitionNumber, may be configured to a CSI-RS resource set configured with trs-Info. The parameter may, for example, take on the values 1, 2, or 3 to indicate the number of repetitions in sub-sequent symbols after the explicitly configured CSI-RS resources, or 2, 3, or 4, to indicate the total number of repetitions. The example in FIG. 19 could, for example, be achieved with repetitionNumber=2 in the former example and repetitionNumber=3 in the latter.

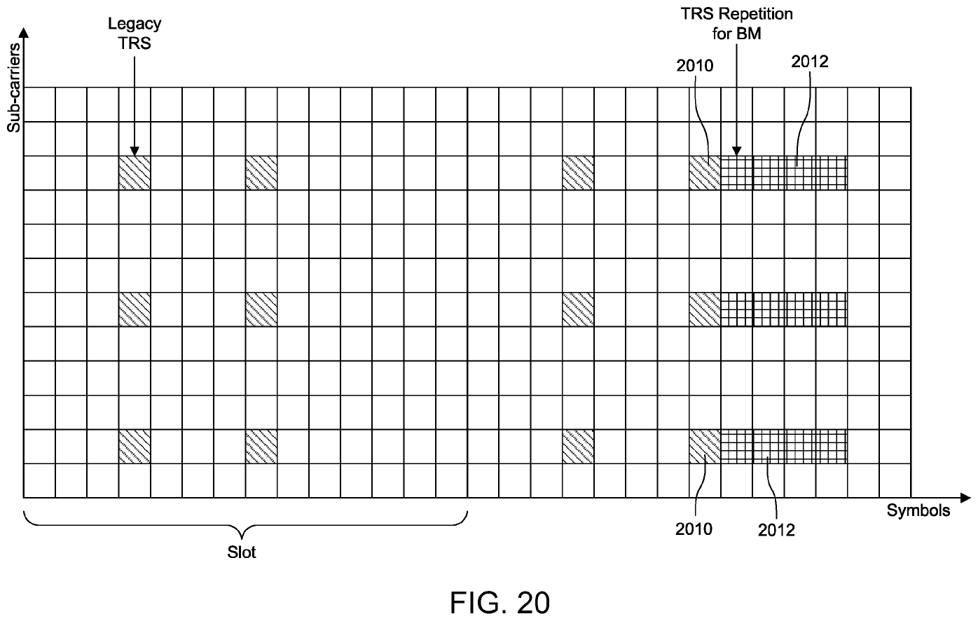

Referring to FIG. 20, in another variation, only one or a subset of the legacy TRS CSI-RS resources 2010 may be followed by repetition(s) 2012. Similar to the previous examples, the repetitions 2012 may be achieved by configuring additional CSI-RS resources to the CSI-RS resource set. Alternatively, also similar to the previous example, the resource set may be configured with an optional repetitionNumber parameter. In this case, a higher number of repetitions may be configured, e.g, if the repetitions occur after the 2^{nd} CSI-RS resource in the time slot or in other previous TRS unused symbols in the time slot. Furthermore, it may be configurable after which of the 2 or 4 CSI-RS resources in a legacy TRS that the repetitions occur, for instance, by an optional parameter repetitionResource, which may, for instance, be 0, 1, 2, or 3, indicating the 1^{st}, 2 ng, 3rd, or 4th resource in the TRS. Alternatively, the repetition resource is fixed, for example, to the last one. The pattern in FIG. 20 may, for example, be achieved by setting repetitionNumber=4 (if additional transmissions are counted) or repetitionNumber=5 (if total number of sub-sequent transmissions are counted). The example parameter repetitionResource could be configured to 3 for the example illustrated in FIG. 20, since the repetitions occur after the last symbol. Note that a DL burst (format) may include no CSI-RS.

Different WTRUs may have different capabilities, e.g., in terms of processing timelines. Prior to the configuration and use of DL bursts, a WTRU may report its relevant capabilities to the network. These capabilities may include one or more of the following:
Minimum time between a PDCCH and SRS triggered by the PDCCH.
Minimum time between a PDCCH and an AP CSI-RS triggered by the PDCCH
Minimum time between a CSI-RS and a PDSCH, for example when the CSI-RS is QCL source RS to the PDSCH DMRS.
The CSI-RS may be a TRS, CSI-RS for beam management, TRS with beam management, etc.
The minimum time may be different for different QCL types and may be different in different frequency ranges. For example, the minimum time may be 0 in FR1.
Minimum time between a PDCCH (without blind decoding), e.g., a 2^{nd} PDCCH or subsequent PDCCH, and corresponding PDSCH.
Minimum time between a DCI multiplexed in a PDSCH and an RS triggered by the DCI. The time may be different for different RS, e.g., SRS or CSI-RS.
PDSCH processing timeline if DCI is multiplexed in the PDSCH, e.g., when the DCI includes various information related to the PDSCH reception and/or decoding such as MCS.

DL bursts can be configured, activated, and/or triggered. The network may configure the WTRU with a DL burst configuration, which may include one or more DL burst formats. A DL burst configuration may also include various other configuration parameters, of which several have been mentioned above. A DL burst format may be based on the WTRU capability, e.g., it may not break the minimum timelines reported by the WTRU. The network may also take WTRU traffic (including QoS requirements) and mobility into account when configuring the DL bursts, as well as considerations on scheduling and system efficiency, etc. Hence, the network may configure different WTRUs with different DL burst formats, for example, due to different WTRU processing capabilities, traffic, and mobility.

A DL burst configuration may be configured per DL BWP, or per serving cell.

The configuration of a TDRA table for scheduling multiple PDSCHs with a single DCI may be supported. This feature may be a building block in a DL burst format configuration.

The separate configuration of aperiodic and semi-persistent SRS resources and SRS resource sets, which may be identified through their IDs may also be supported. Aperiodic SRS resources have configurable slot offsets and symbol allocations.

Similarly, CSI-RS resources and CSI-RS resource sets of various types may also be configured and identified through their IDs.

One way to configure DL burst formats is to associate zero, one, or more SRS resources or SRS resource sets to a row in a configured PDSCH TDRA table (e.g., as described above). Since one row of the PDSCH TDRA table corresponds to one or more PDSCH, each with an individual time-slot offset in relation to the scheduling DCI (e.g., the 1^{st} DCI, or 2^{nd} DCI, or subsequent DCI) and a symbol allocation within its time slot, the network may also configure a set of SRS resources for the row with a timing that is suitable to the number of PDSCH, and their time offset(s).

This may, for instance, be achieved by configuring a list of PDSCH TDRA table row indices in an SRS resource or SRS resource set (e.g., AP or SP SRS). When a certain PDSCH TDRA table row index, e.g., index i, is indicated in a DCI, e.g., the 1^{st} DCI, 2^{nd} DCI, or a subsequent DCI, each SRS resource set that has that particular TDRA table row index, e.g., i, configured in its list is triggered/activated by the DCI. An SRS resource without the list configured or with an empty list will not be triggered/activated by any TDRA index in a DCI (however, it may be triggered by legacy methods, such as a particular SRS request value, if available).

An alternative approach to link a PDSCH TDRA table row with one or more SRS resource sets (or resources) is to configure a list of SRS resource set IDs (or resource IDs) in the configuration of the TDRA table row.

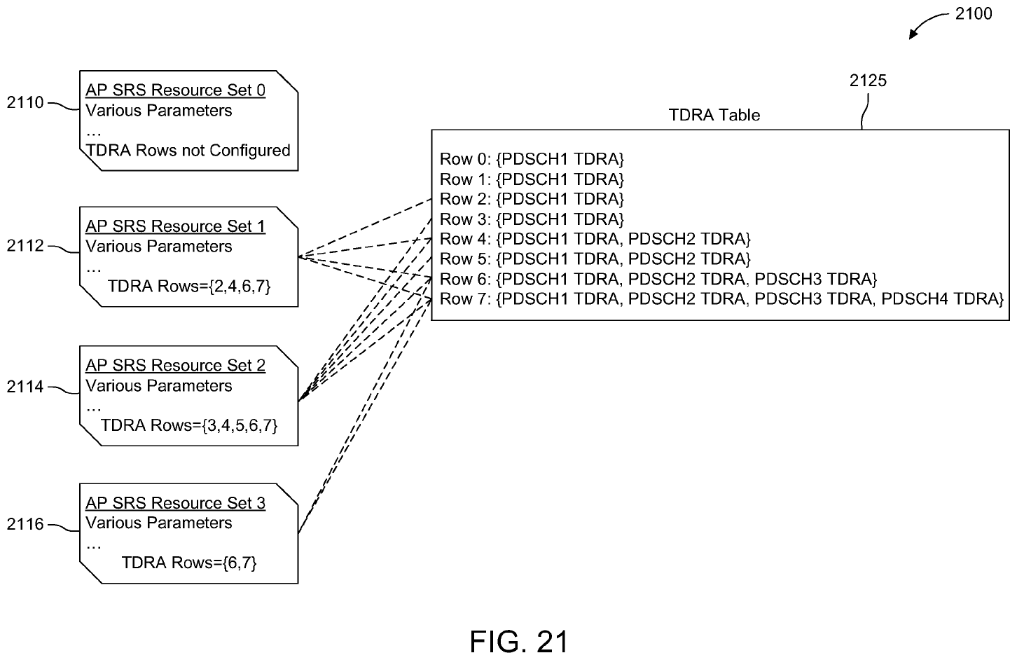

FIG. 21 shows an exemplary illustration of the linking 2100 between aperiodic SRS resource sets 2110, 2112, 2114, 2116 and rows in an 8-row TDRA table 2125. Rows 2-7 may correspond to DL bursts since a TDRA table row index between 2 and 7 would schedule/activate both PDSCH according to the TDRA as well as the corresponding SRS resource sets 2112, 2114 and 2116 based on the linkage between AP SRS resource sets and TDRA row indices. In this example, Rows 0 and 1 are not linked with SRS resources, so the indication of rows 0 or 1 may correspond only to a PDSCH TDRA. However, AP SRS may be triggered with the legacy SRS request field for TDRA row 0 or 1, if present. The example also shows that AP SRS resource set 0 2110 does not have the TDRA rows parameter configured. This means that it is not linked to (and therefore triggered by) certain TDRA table row indexes.

In an alternative or complementary approach, a MAC CE may be used to associate one or more SRS resources or SRS resource sets with a TDRA row index The association of a new set of SRSs to a TDRA row index may clear previously associated one or more SRSs with the index. Note that the method described above may eliminate the need for the SRS request field in the DCI and might not increase the number of bits to indicate a TDRA table row, while at the same time the method may increase, significantly, the potential to improve/adapt SRS transmission to the dynamically scheduled TDRA(s) of one or more PDSCHs.

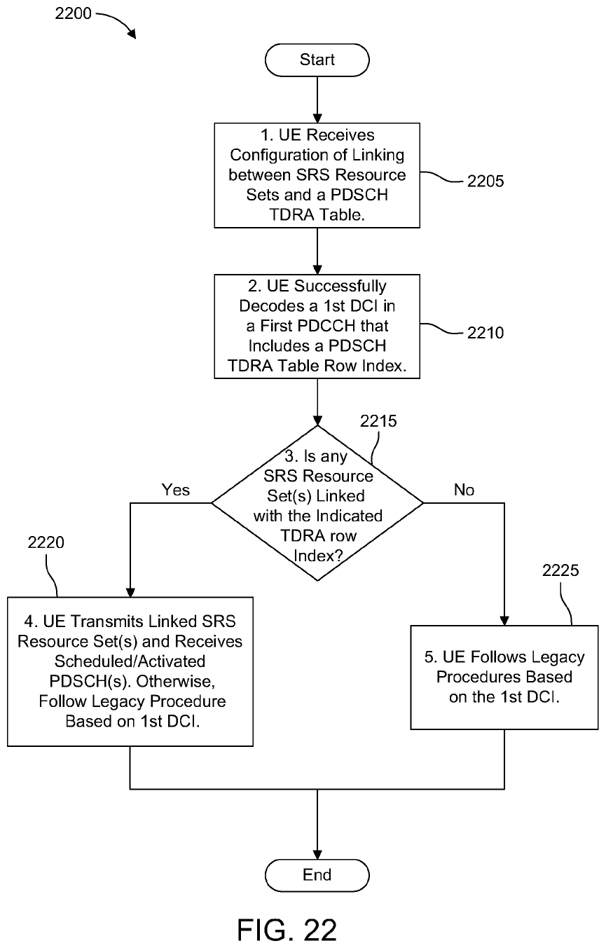

Turning to FIG. 22, an exemplary method 2200 for a WTRU is shown. In the first step, the WTRU may be configured 2205 with SRS resource sets (e.g., AP or SP SRS) and a PDSCH TDRA table. One or more SRS resource sets may be configured to be linked with one or more TDRA table rows, per the previous examples in FIG. 21. In the second step the WTRU may decode 2210 a 131 DCI that schedules PDSCH (e.g., DCI format 1_0, 1_1, 1, 2, or new DCI format) and contains a TDRA field that indicates a TDRA table row. In the third step, the WTRU may determine 2215 whether any SRS resource set is linked with the indicated TDRA table row. If so, in the fourth step the linked SRS resource sets may be triggered/activated 2220 and therefore transmitted by the WTRU. Beside the transmission of one or more linked SRSs, the WTRU may follow legacy procedures. The WTRU may receive the scheduled PDSCH(s). If no SRS resource set was linked 2215 with the indicated TDRA table row, then in a fifth step the WTRU may follow 2225 legacy procedures and receive the scheduled PDSCH(s) accordingly.

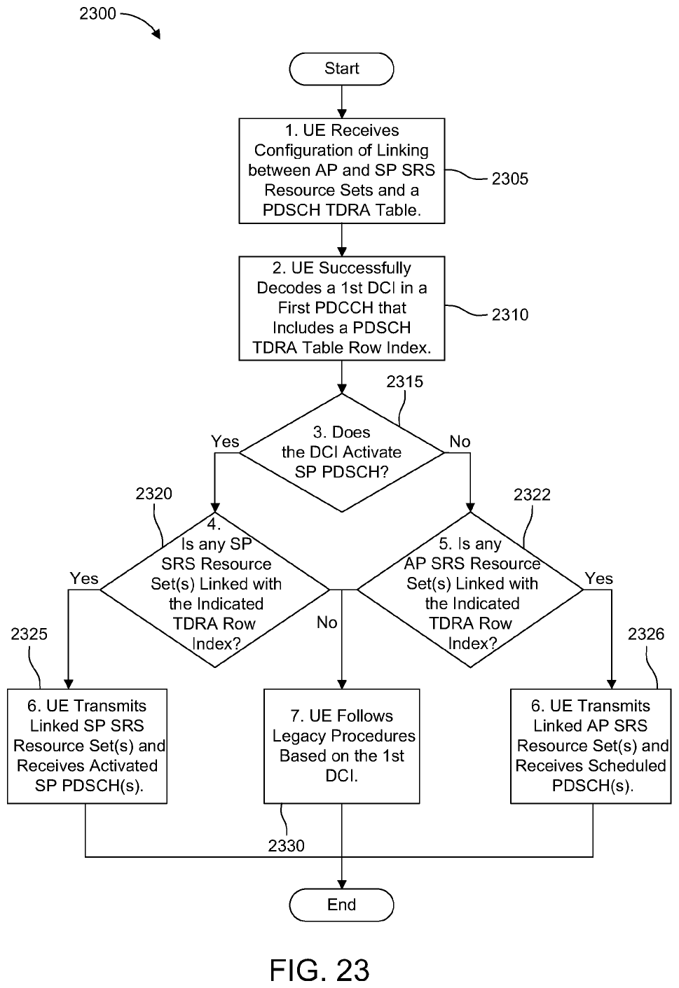

Referring to FIG. 23, in an exemplary method 2300, SP SRS resource sets may be linked 2305 to the TDRA table rows. If the 1^{st} DCI activates one or more SP PDSCHs by indicating a row in the TDRA table, the linked SP SRS resource sets may be activated as well. A TDRA table row may be linked to both AP SRS resource set(s) and SP SRS resource set(s). In order to handle such a case, in the 1^{st} step, the WTRU may be configured 2305 with a linkage between one or more AP SRS resource sets and one or more rows in a PDSCH table and a linkage between one or more SP SRS resource sets and one or more rows in the PDSCH table. In the 2^{nd} step, the WTRU may decode 2310 a 1^{st} DCI that schedules PDSCH (e.g., DCI format 1_0, 1_1, 1_2, or new DCI format) and contains a TDRA field that indicates a TDRA table row. In the 3rd step, the WTRU may determine 2315 if the DCI activates an SP PDSCH. If so, in step 4 the WTRU may determine 2320 if there is any SP resource set(s) linked with the indicated TDRA row. If so, in step 6 the WTRU may transmit 2325 the linked SP SRS resource set(s), e.g., after activating the SP SRS resource set(s) or after interpreting the indicated TDRA row as an SP SRS resource set activation command. If no SP resource set is linked 2320 with the indicated TDRA row, in step 5 the WTRU may follow 2330 legacy procedures. If the DCI doesn't activate 2315 an SP PDSCH in step 3, but instead dynamically schedules one or more PDSCHs, in step 5 the WTRU may determine 2322 if there is any AP resource set(s) linked with the indicated TDRA row. If so, in step 8 the WTRU may transmit 2326 the linked AP SRS resource set(s). If no AP resource set is linked with the indicated TDRA row, in step 5 the WTRU may follow 2330 legacy procedures.

For brevity, various examples herein describe the linking of a PDSCH TDRA table row and one or more SRS resource sets. CSI-RS may be linked by similar methods, thereby providing unified and efficient triggering/activation and TDRA of PDSCH, SRS and CSI-RS in a DL burst. In other words, a CSI-RS resource set (e.g., a NZP CSI-RS resource set, or a ZP CSI-RS resource set, or a CSI interference measurement (IM) resource set) may be configured with a list of PDSCH TDRA table row indexes, for which the CSI-RS resource set may be triggered (for AP CSI-RS) or activated (for SP CSI-RS). Alternatively, the configuration of a PDSCH TDRA table row may include a list of CSI-RS resource set IDs.

Similarly, one or more PUCCH resource allocations may be linked with a PDSCH TDRA table.

In another exemplary method, a DL burst format table or DL burst format list is configured A row (entry) of the DL burst format table (list) may include a reference to a row in the PDSCH TDRA table, thereby providing the TDRA for the PDSCH in the burst. A DL burst format table row may also include one or more references to SRS resource sets (e.g., AP or SP SRS resource sets) and/or CSI-RS resource sets, for instance, by providing a list of SRS/CSI-RS resource set IDs in the configuration of a row, and PUCCH resource(s). If a WTRU is configured with DL bursts enabled, a DCI may include a DLL burst format indicator field, which may indicate a row in the DL burst format table that in turn provides the TDRA for various signals/channels in the DL burst, such as SRS, CSI-RS, PUCCH.

In some cases, if SP transmission of PDSCH is activated, and a TDRA table row is indicated to which one or more AP SRS resource set(s) is linked, the AP SRS resource set(s) may be repeated in the subsequent SP DL bursts (until deactivation), using the same relative resource allocation between SRS and PDSCH as in the first DL burst.

In another exemplary approach to configure SRS and/or CSI-RS in a burst, a time offset to a PDSCH is configured, rather than a time offset to a DCI The example of SRS is used below for simplicity, but it may also apply to CSI-RS. The time offset may be in terms of time slots as in examples discussed below, but it may also be in another unit such as symbols.

An SRS resource (or SRS resource set) may occur or start M time slots before the time slot of a PDSCH transmission. Alternatively, an SRS resource (or SRS resource set) may occur or start M symbols before the start of a PDSCH transmission. For example, an SRS resource may occur M time slots (or symbols) before each PDSCH transmission in a DL burst. The value of M may be for example 1, 2, or 3, etc. M may be fixed or configurable, for example, for a BWP, a DL burst format, a PDSCH transmission within a DL burst format, an SRS resource, or an SRS resource set. The SRS resource (set) may, for example, be AP or SP.

In some cases, a symbol designated for an SRS transmission may be assigned to DL transmission, e.g., according to a configured or indicated time-slot format. In other cases, a symbol designated for an SRS transmission may be assigned as flexible symbols or UL symbols, but they may have been assigned to another signal/channel which may have higher priority, e.g., a synchronization signal, and SSB, a PUCCH transmission, a PUSCH transmission, etc. If so, the SRS may have to be dropped, or adjusted in frequency or in time.

If dropped, the corresponding colliding SRS resource or even the whole SRS resource set may be dropped.

If adjusted in frequency, e.g., if the designated SRS transmission collides with another higher priority UL transmission, the SRS transmission is adjusted such that it is not transmitted on the colliding RBs, e.g., by not transmitting the SRS resource on the colliding RBs, or by adjusting the starting RB of the SRS resource enough to avoid the collision.

If adjusted in time, e.g., if a designated SRS resource collides with a DL symbol(s) or with a higher priority transmission in a flexible or UL symbol(s) (the original symbol(s), the corresponding SRS resource may be moved to one or more earlier or later symbol(s) that are valid for the SRS transmission, e.g., the latest symbol(s) before the original symbol(s) where the SRS resource may be transmitted, or the earliest symbol(s) after the original symbol(s) where the SRS resource may be transmitted. A multi-symbol SRS resource on consecutive symbols may be shifted (earlier or later) such that the adjusted SRS resource also falls on consecutive symbols. Alternatively, a multi-symbol SRS resource on consecutive symbols may be adjusted such that the adjusted SRS no longer falls on consecutive symbols. For example, only a colliding SRS symbol of an SRS resource and the SRS symbols of the SRS resource prior to the colliding SRS symbol may be moved earlier to valid symbol(s). Alternatively, only a colliding SRS symbol of an SRS resource and the SRS symbols of the SRS resource after the colliding SRS symbol may be moved later to valid symbol(s).

In one example, the time offset M may be applied for an SRS resource (or SRS resource transmission) if a time-slot offset is not configured for the SRS resource. In another example, time offset M may be applied for an SRS resource (or SRS resource transmission) even if a (legacy) time-slot offset has been configured, for example if the SRS resource transmission has been triggered/activated to be a part of a DL burst, for example, based on a linkage between the SRS resource and a PDSCH TDRA table row. In such a case, the configured (legacy) time-slot offset may be ignored. In another example, a WTRU may be configured to interpret the (legacy) time-slot offset parameter in an SRS resource configuration as M (or M plus a known integer).

In some cases, an SRS resource (set) may be transmitted before every N^{th} PDSCH transmission in a DL burst. For example, if N=2, SRS is transmitted before the 1^{st} PDSCH and before the 3^{rd} PDSCH in the DL burst, etc. Alternatively, a first SRS resource (set) may be transmitted before the 1^{st} PDSCH and then SRS (a first SRS resource (set) or a second SRS resource (set) may be transmitted in a time slot that is N time slots (or at least N time slots) after the first transmission of the first SRS resource (set) transmission.

The SRS resource (set) transmission M time slots before PDSCH transmission(s) may be combined with SRS before every N^{th} PDSCH/slot. For example, with M=1 and M=4, an SRS is transmitted in the slot before every 4^{th} PDSCH. Alternatively, a first SRS transmission is in the time slot before the 1^{st} PDSCH and in the time slot before a subsequent PDSCH (not necessarily the 2^{nd} PDSCH) such that the time slot of the subsequent SRS is at least 4 time slots after the time slot of the first SRS transmission, etc. In yet another alternative, a first SRS transmission is in the time slot before the 1^{st} PDSCH and in the time slot before a subsequent PDSCH such that the time slot of the subsequent PDSCH is at least 4 time slots after the time slot of the first SRS transmission. Methods such as these may be useful to render the CSI that is to be applied to a PDSCH in the DL burst not older than a certain age and up to date, which status may be determined from the value(s) of M and/or N.

In some cases, a subset of the configured burst formats can be selected by MAC CE and mapped to codepoints of a DCI field. e.g., a burst format indicator field, a TDRA field, etc. This would allow the configuration of a large set of burst formats while a typically small subset can be indicated by DCI. The subset may be dynamically adapted (by MAC CE) to WTRU traffic, service type, signal quality, channel conditions, network load, etc.

A WTRU may be configured by the network with one or more SRS resources, one or more CSI-RS resources, and one or more time-domain resource allocations (TDRA) for PDSCH(s). The WTRU may be configured by the network with a linkage between a TDRA and one or more SRS resources. The WTRU may also be configured with a linkage between a TDRA and one or more CSI-RS resources.

The WTRU may receive a first DCI that includes a field with an indication of one of the one or more TDRAs for one or more PDSCHs and an indication of a PDSCH frequency domain resource allocation (FDRA). The first DCI may indicate a first set of parameters for the one or more PDSCH(s). If the indicated TDRA is linked with one or more SRS resources, then the WTRU transmits the one or more SRS resources. The transmission timing of the one or more SRS resources may depend on the transmission timing of the one or more PDSCH(s). The frequency resource allocation of the one or more SRS resources may depend on the indicated PDSCH FDRA.

If the indicated TDRA is linked with one or more CSI-RS resources, then the WTRU receives the one or more CSI-RS resources. The WTRU receives a 2^{nd} DCI in a second PDCCH or multiplexed with one of the one or more PDSCH(s) and the 2^{nd} DCI indicates a second set of parameters for the one or more PDSCH(s). The WTRU receives the one or more PDSCH(s) based on the indicated first set of parameters, including TDRA and FDRA, and the second set of parameters.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method implemented by a wireless transmit receive unit (WTRU) for wireless communications, the method comprising:
receiving configuration information including a downlink (DL) burst format table defining a plurality of DL burst formats, wherein each DL burst format of the plurality of DL burst formats indicates a respective time domain resource allocation (TDRA) of one or more physical downlink shared channels (PDSCHs) and one or more sounding reference signal (SRS) resources associated with the each respective DL burst format;
receiving downlink control information (DCI) with a single field indicating a DL burst format from the plurality of DL burst formats;
transmitting a SRS using one or more SRS resources associated with the indicated DL burst format;
and
receiving the one or more PDSCHs using a TDRA associated with the indicated DL burst format.

2. The method of claim 1, wherein the configuration information includes an SRS resource including an SRS frequency domain resource allocation (FDRA), and wherein the received DCI indicates identified frequency resources for a scheduled PDSCH, the method further comprising:
determining a set of SRS frequency domain resources for transmitting the SRS based on the configured SRS FDRA and the identified frequency resources of the scheduled PDSCH.

3. The method of claim 1, further comprising:
receiving a second DCI with the field indicating one or more transmission or reception parameters for one or more signals in the DL burst.

4. The method of claim 3, wherein the DCI and second DCI are received in different bandwidth parts (BWPs).

5. A wireless transmit receive unit (WTRU) comprising:
a transceiver; and
a processor in communication with the transceiver, the processor and transceiver adapted to:
receive configuration information including a downlink (DL) burst format table defining a plurality of DL burst formats, wherein each DL burst format of the plurality of DL burst formats indicates a respective time domain resource allocation (TDRA) of one or more physical downlink shared channels (PDSCHs) and one or more sounding reference signal (SRS) resources associated with the each respective DL burst format;
receive downlink control information (DCI) with a single field indicating a DL burst format from the plurality of DL burst formats;
transmit a SRS using one or more SRS resources associated with the indicated DL burst format;
and
receive one or more PDSCHs using a TDRA associated with the indicated DL burst format.

6. The WTRU of claim 5, wherein the configuration information includes an SRS resource including an SRS frequency domain resource allocation (FDRA), wherein the received DCI indicates frequency resources for a scheduled PDSCH, and wherein the processor is configured to determine a set of SRS frequency domain resources for transmitting the SRS based on the configured SRS FDRA and the identified frequency resources of the scheduled PDSCH.

7. The WTRU of claim 5, wherein the processor and transceiver are further adapted to:
receive a second DCI with the field indicating one or more transmission or reception parameters for one or more signals in the DL burst.

8. The WTRU of claim 7, wherein the DCI and second DCI are received in different bandwidth parts (BWPs).

9. A method for a wireless base station, the method comprising:
sending configuration information to a wireless transmit receive unit (WTRU), the configuration information including a downlink (DL) burst format table defining a plurality of DL burst formats, wherein each DL burst format of the plurality of DL burst formats indicates a time domain resource allocation (TDRA) of one or more physical downlink shared channels (PDSCHs), and one or more sounding reference signal (SRS) resources associated with the each respective DL burst format;
sending downlink control information (DCI) to the WTRU, the DCI including a single field indicating a DL burst format from the plurality of DL burst formats;
receiving a SRS transmitted by the WTRU using one or more SRS resources associated with the indicated DL burst format;
and
transmitting one or more PDSCHs using the TDRA associated with the indicated DL burst format.

10. The method of claim 9, wherein the configuration information includes an SRS resource including an SRS frequency domain resource allocation (FDRA), wherein the DCI indicates identified frequency resources for a scheduled PDSCH, and wherein the received SRS uses frequency resources based on the SRS FDRA and the identified frequency resources of the scheduled PDSCH.

11. The method of claim 9, further comprising:
measuring one or more characteristics of the received SRS; and
sending a second DCI to the WTRU with the field indicating an updated DL burst format from the plurality of DL burst formats based on the measured one or more characteristics of the received SRS.

12. The method of claim 11, wherein the DCI and the second DCI are sent in different bandwidth parts (BWPs).

13. The method of claim 1, wherein the configuration information further comprises channel state information reference signal (CSI-RS) resources associated with the DL burst format, and wherein the method further comprises:
receiving a CSI-RS, using the one or more CSI-RS resources associated with the indicated DL burst format.

14. The WTRU of claim 5, wherein the configuration information further comprises channel state information reference signal (CSI-RS) resources associated with the DL burst format, and wherein the processor and the transceiver are further adapted to:
receive a CSI-RS, using the one or more CSI-RS resources associated with the indicated DL burst format.

15. The method of claim 9, wherein the configuration information further includes one or more channel state information reference signal (CSI-RS) resources associated with the DL burst format, and wherein the method further comprises:
transmitting a CSI-RS to the WTRU using the one or more CSI-RS resources associated with the indicated DL burst format.
